(19) United States
(12) Patent Application Publication
(10) Pub. No.: US 2023/0280747 A1
(43) Pub. Date: Sep. 7, 2023

(54) ROAD SIDE MACHINE, VEHICLE, CONTROL DEVICE, AND VEHICLE CONTROL METHOD

(71) Applicant: PANASONIC INTELLECTUAL PROPERTY MANAGEMENT CO., LTD., Osaka (JP)

(72) Inventors: Eunhye CHO, Kanagawa (JP); Akiyoshi NAGUMO, Kanagawa (JP); Takenobu ARIMA, Kanagawa (JP); Jinsong DUAN, Tokyo (JP); Hideki TAMURA, Kanagawa (JP)

(73) Assignee: PANASONIC INTELLECTUAL PROPERTY MANAGEMENT CO., LTD., Osaka (JP)

(21) Appl. No.: 18/197,404

(22) Filed: May 15, 2023

Related U.S. Application Data
(63) Continuation of application No. PCT/JP2021/041435, filed on Nov. 10, 2021.

(30) Foreign Application Priority Data
Nov. 16, 2020 (JP) 2020-190452
Dec. 18, 2020 (JP) 2020-210466

(51) Int. Cl. G05D 1/00; H04W 4/44

(52) U.S. Cl. CPC G05D 1/0061; H04W 4/44; G05D 2201/0213

(57) ABSTRACT

A vehicle communicating with first and second wireless communication terminal and second wireless communication terminals includes a manual driving mode and an autonomous driving mode. In the manual driving mode, when a predetermined relationship with the first wireless communication terminal is established, manual driving by the occupant is possible, and when the predetermined relationship with the first wireless communication terminal is not established, the manual driving is impossible, and when the predetermined relationship with the first wireless communication terminal is established, transition to the manual driving mode is possible. In the autonomous driving mode, when the predetermined relationship with the first wireless communication terminal is not established, the transition to the manual driving mode is impossible, and when the predetermined relationship with the first wireless communication terminal is not established, the transition to the manual driving mode is possible by a predetermined operation of the second wireless communication terminal.

### CROSS-REFERENCE TO RELATED APPLICATIONS

This is a continuation of International Application No. PCT/JP2021/041435 filed on Nov. 10, 2021, and claims priority from Japanese Patent Application No. 2020-190452 filed on Nov. 16, 2020 and Japanese Patent Application No. 2020-210466 filed on Dec. 18, 2020, the entire content of which is incorporated herein by reference.

### TECHNICAL FIELD

The present disclosure relates to a road side machine, a vehicle, a control device, and a vehicle control method.

### BACKGROUND ART

Patent Literature 1 discloses a driving assist image display system including a road side machine that transmits information on a situation of an intersection to a right-turn vehicle, and an in-vehicle device that displays a driving assist image based on the information received from the road side machine. The road side machine acquires a predetermined physical quantity related to an oncoming right-turn vehicle and a hidden oncoming vehicle that is hidden by the oncoming right-turn vehicle, and a predetermined physical quantity related to the intersection, and transmits the two predetermined physical quantities to the right-turn vehicle. The in-vehicle device mounted in the right-turn vehicle receives the information transmitted from the road side machine, superimposes an image of the intersection from a point of view obtained by simulating a view of a driver of the right-turn vehicle based on the information, an image of the oncoming right-turn vehicle and an image of the hidden oncoming vehicle, and draws and displays a driving assist image that visualizes the hidden oncoming vehicle by transmitting the image of the oncoming right-turn vehicle.

### CITATION LIST

### Patent Literature

Patent Literature 1: JP2009-20675A

### SUMMARY OF INVENTION

However, in a configuration in Patent Literature 1, when a plurality of road side machines are provided, it is not possible to determine from which road side machine the information received by the in-vehicle device mounted in the right-turn vehicle is transmitted, and there is a possibility that an image for appropriate driving assistance cannot be presented to the driver.

An object of the present disclosure is to present an image for appropriate driving assistance to a driver of a vehicle.

A vehicle according to an aspect of the present disclosure includes a first wireless communication circuit configured to communicate with a first wireless communication terminal, and a second wireless communication circuit configured to communicate with a second wireless communication terminal different from the first wireless communication terminal. The vehicle includes a manual driving mode in which an occupant of the vehicle manually drives the vehicle, and an autonomous driving mode in which the occupant is capable of autonomously moving the vehicle without boarding the vehicle. In the manual driving mode, when a predetermined relationship with the first wireless communication terminal is established, manual driving by the occupant is possible. In the manual driving mode, when the predetermined relationship with the first wireless communication terminal is not established, the manual driving by the occupant is impossible. In the autonomous driving mode, when the predetermined relationship with the first wireless communication terminal is established, transition to the manual driving mode is possible. In the autonomous driving mode, when the predetermined relationship with the first wireless communication terminal is not established, the transition to the manual driving mode is impossible. In the autonomous driving mode, when the predetermined relationship with the first wireless communication terminal is not established, the transition to the manual driving mode is possible by a predetermined operation of the second wireless communication terminal.

A road side machine according to an another aspect of the present disclosure includes: an imaging unit configured to image a vehicle in a predetermined imaging direction on a road; and a communication unit configured to output a position of the imaging unit, the predetermined imaging direction, and an image captured by the imaging unit as a communication signal.

A vehicle according to an another aspect of the present disclosure includes: at least a first wheel and a second wheel; a vehicle body coupled to the first wheel and the second wheel; a wireless communication unit configured to receive a position of an imaging unit provided in a road side machine, an imaging direction of the imaging unit, and an image captured by the imaging unit; and a display unit, in which the display unit displays the image captured by the imaging unit based on the position of the imaging unit and the imaging direction of the imaging unit.

A control device according to an another aspect of the present disclosure which is mountable on a vehicle including at least a first wheel and a second wheel, a vehicle body coupled to the first wheel and the second wheel, a wireless communication unit configured to receive a position of an imaging unit provided in a road side machine, an imaging direction of the imaging unit, and an image captured by the imaging unit, and a display unit, in which the control device displays, on the display unit, the image captured by the imaging unit based on the position of the imaging unit and the imaging direction of the imaging unit.

A vehicle control method according to an another aspect of the present disclosure which is usable in a vehicle including at least a first wheel and a second wheel, a vehicle body coupled to the first wheel and the second wheel, a wireless communication unit configured to receive a position of an imaging unit provided in a road side machine, an imaging direction of the imaging unit, and an image captured by the imaging unit, and a display unit, the vehicle control method including: displaying, on the display unit, the image captured by the imaging unit based on the position of the imaging unit and the imaging direction of the imaging unit.

These comprehensive or specific aspects may be implemented by a system, an apparatus, a method, an integrated circuit, a computer program, or a recording medium, or any combination of the system, the apparatus, the method, the integrated circuit, the computer program, and the recording medium.

According to the present disclosure, it is possible to present an image for appropriate driving assistance to a driver of a vehicle.

### BRIEF DESCRIPTION OF DRAWINGS

Exemplary embodiment(s) of the present invention will be described in detail based on the following figures, wherein:

FIG. 1 is a diagram illustrating an example of a vehicle according to a first embodiment;

FIG. 2 is a block diagram illustrating an example of a configuration of a device in the vehicle according to the first embodiment;

FIG. 3A is a diagram illustrating an example of a first display in an in-vehicle display circuit according to the first embodiment;

FIG. 3B is a diagram illustrating an example of a second or third display in the in-vehicle display circuit according to the first embodiment;

FIG. 4A is a diagram illustrating a display example during autonomous driving in an out-of-vehicle display circuit according to the first embodiment;

FIG. 4B is a diagram illustrating a display example during manual driving in the out-of-vehicle display circuit according to the first embodiment;

FIG. 5 is a flowchart illustrating an example of a process of starting the vehicle by a first wireless communication terminal according to the first embodiment;

FIG. 6 is a flowchart illustrating an example of a process of starting the vehicle by a second wireless communication terminal according to the first embodiment;

FIG. 7 is a flowchart illustrating an example of a remote user authentication process performed by the second wireless communication terminal according to the first embodiment;

FIG. 8 is a flowchart illustrating an example of a manual driving mode switching process according to the first embodiment;

FIG. 9 is a schematic diagram illustrating a situation in which a vehicle according to a second embodiment turns right at an intersection;

FIG. 10 is a schematic diagram illustrating an example of a configuration of the vehicle according to the second embodiment;

FIG. 11 is a block diagram illustrating an example of configurations of a road side machine and the vehicle according to the second embodiment;

FIG. 12 is a diagram illustrating an example of a data format of V2I information according to the second embodiment;

FIG. 13 is a flowchart illustrating an example of a driving assist process according to the second embodiment;

FIG. 14 is a schematic diagram illustrating an example of a display of a captured image on a display unit according to the second embodiment;

FIG. 15 is a schematic diagram illustrating a situation in which a vehicle according to a third embodiment turns right at an intersection;

FIG. 16 is a schematic diagram illustrating a situation in which the vehicle according to the third embodiment turns left at the intersection;

FIG. 17 is a flowchart illustrating an example of a driving assist process according to the third embodiment;

FIG. 18 is a schematic diagram illustrating an example of a captured image displayed on a display unit when the vehicle according to the third embodiment turns right; and

FIG. 19 is a schematic diagram illustrating an example of the captured image displayed on the display unit when the vehicle according to the third embodiment turns left.

### DESCRIPTION OF EMBODIMENTS

Hereinafter, embodiments of the present disclosure will be described in detail with reference to the drawings as appropriate. However, the unnecessarily detailed description may be omitted. For example, the detailed description of already well-known matters and the repeated description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit the subject matter described in the claims.

### First Embodiment

### Background of Present Disclosure

A user (for example, a driver) of a vehicle includes a frequency operated button key (FOB Key) serving as a key that releases a door lock of the vehicle, starts an engine, and the like. The user can release the door lock using the FOB key, board the vehicle, start the engine, and allow the vehicle to travel. In a case in which the vehicle has an autonomous driving function, when the user selects an autonomous driving mode, the vehicle autonomously travels to a destination. When the user performs an operation (for example, a steering wheel operation or a brake operation) related to manual driving during operation in the autonomous driving mode, the vehicle transfers an operation authority to the user. Further, in a case in which a situation in which autonomous determination cannot be performed occurs in the autonomous driving mode, the vehicle transfers the operation authority to the user. Such a transfer of the operation authority of the vehicle to the user during autonomous driving is referred to as an “authority transfer”.

As represented by auto valet parking, it is being considered to autonomously drive an unmanned vehicle which a person does not board to the destination (for example, a parking position). For example, a person (movement authorized person) who has accepted a movement authority of the vehicle without receiving the FOB key from the user operates a predetermined management terminal to cause the unmanned vehicle to autonomously travel to the destination. In this case, when a thief gets into the unmanned vehicle during the autonomous driving and performs the operation related to the manual driving, the authority transfer occurs and the driving is switched to the manual driving. That is, the vehicle may be stolen by the thief.

If the authority transfer is not permitted when the FOB key is not present in the vehicle, it is considered that a theft of the unmanned vehicle which is performed by the above-described thief can be prevented. However, in this case, even when the FOB key of the user driving the vehicle fails or is lost, the authority transfer is not permitted. Even when a situation in which the manual driving performed by the movement authorized person is necessary occurs in the auto valet parking or the like, the movement authorized person cannot perform the manual driving since the movement authorized person does not have the FOB key.

Therefore, in the following, a first embodiment will be described in which the user and the movement authorized person can appropriately perform autonomous driving and the manual driving of the vehicle while preventing the theft of the vehicle.

<Configuration of Vehicle>

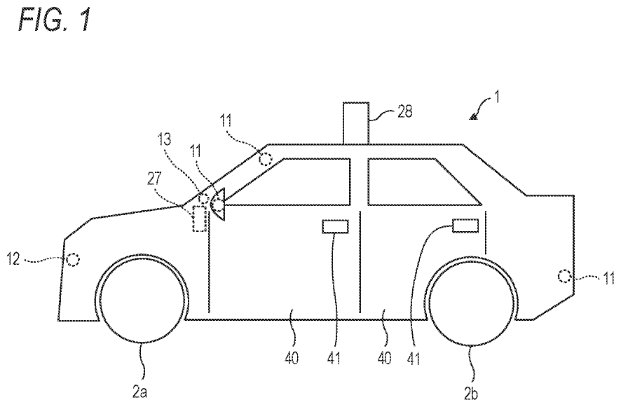

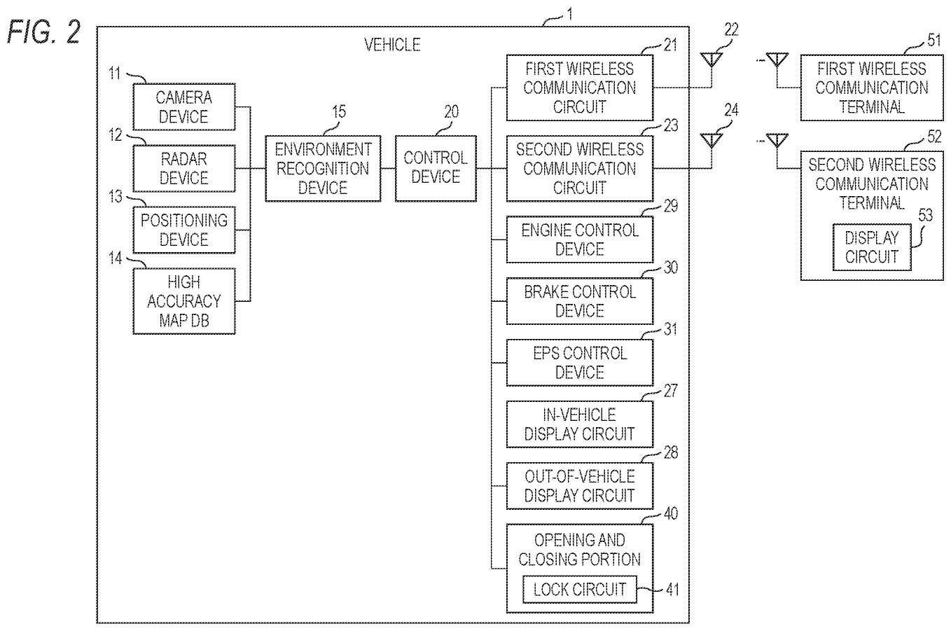

A configuration of a vehicle 1 according to the first embodiment will be described with reference to FIGS. 1 and 2. FIG. 1 is a diagram illustrating an example of the vehicle 1 according to the first embodiment. FIG. 2 is a block diagram illustrating an example of a configuration of a device in the vehicle 1 according to the first embodiment.

The vehicle 1 includes first wheels 2a and second wheels 2b coupled to a vehicle body, and is movable using the first wheels 2a and the second wheels 2b. The first wheels 2a may be front wheels of the vehicle 1, and the second wheels 2b may be rear wheels of the vehicle 1. In the present embodiment, a case in which the vehicle 1 includes four wheels will be described, but the vehicle 1 may include two wheels, three wheels, or five or more wheels. Alternatively, the vehicle 1 may be an unmanned aerial vehicle that does not include wheels represented by a drone.

The vehicle 1 includes camera devices 11, a radar device 12, a positioning device 13, a high accuracy map database (DB) 14, an environment recognition device 15, a control device 20, a first wireless communication circuit 21, a second wireless communication circuit 23, an in-vehicle display circuit 27, an out-of-vehicle display circuit 28, an engine control device 29, a brake control device 30, and an electric power steering (EPS) control device 31. The vehicle 1 includes opening and closing portions 40 that is opened and closed for getting on and off the vehicle 1.

Each of the high accuracy map DB 14, the environment recognition device 15, the control device 20, the first wireless communication circuit 21, the second wireless communication circuit 23, the engine control device 29, the brake control device 30, and the EPS control device 31 may be configured as an electronic control unit (ECU) including a processor, a memory, and a communication I/F. Each of the high accuracy map DB 14, the environment recognition device 15, the control device 20, the first wireless communication circuit 21, the second wireless communication circuit 23, the engine control device 29, the brake control device 30, and the EPS control device 31 is not limited to being configured as one ECU, and at least two devices may be configured as one ECU. The camera devices 11, the radar device 12, the positioning device 13, the high accuracy map DB 14, the environment recognition device 15, the control device 20, the first wireless communication circuit 21, the second wireless communication circuit 23, the in-vehicle display circuit 27, the out-of-vehicle display circuit 28, the engine control device 29, the brake control device 30, and the EPS control device 31 in the vehicle 1 may be capable of transmitting and receiving information to and from each other through an in-vehicle network. Examples of the in-vehicle network include a controller area network (CAN), a local interconnect network (LIN), and FlexRay.

The camera device 11 captures an image of surroundings of the vehicle 1 and generates a surrounding image. The surrounding image may be either a still image or a moving image. As illustrated in FIG. 1, the vehicle 1 may include the plurality of camera devices 11, and may generate the surrounding image by deforming and synthesizing the captured images of the camera devices 11. Alternatively, the vehicle 1 may include the camera devices 11 capable of capturing images in all directions, and may generate the surrounding image by deforming the captured images of the camera devices 11.

The radar device 12 irradiates the surroundings of the vehicle 1 with radio waves and generates 3D point group data indicating reflection points of the radio waves. The 3D point group data is data including a plurality of points (hereinafter referred to as 3D points) having three-dimensional coordinates. That is, the 3D point group data is data indicating a position and a shape of an object present around the vehicle 1. Also, the radar device 12 may be read as light detection and ranging (LiDAR).

The positioning device 13 measures a position of the vehicle 1 based on a signal received from a global navigation satellite system (GNSS), and generates positioning information indicating a measurement result thereof. The positioning information may include a measured time, and measured longitude and latitude.

The high accuracy map DB 14 is a DB that holds map information indicating a link, a shape, a lane, and the like of a road on which the vehicle 1 travels with high accuracy. The high accuracy map DB 14 may hold the map information indicating a level, a structure, a parking position, and the like of parking with high accuracy. The high accuracy map DB 14 may hold the map information in advance, or may appropriately receive and hold the map information around the vehicle 1 from an external predetermined server through the second wireless communication circuit 23. The map information may be read as another term such as an HD map or a dynamic map.

The environment recognition device 15 recognizes an environment around the vehicle 1 based on the surrounding image received from the camera device 11, the 3D point group data received from the radar device 12, and the positioning information received from the positioning device 13. For example, the environment recognition device 15 recognizes a position, a shape, a line, a road sign, a traffic signal of a road on which the vehicle 1 is traveling, and other vehicles, bicycles, pedestrians, and the like present around the vehicle 1. A recognition result of the environment recognition device 15 may be used for the autonomous driving of the vehicle 1 performed by the control device 20 to be described later. Further, the recognition result of the environment recognition device 15 may be used in advanced driver-assistance systems (ADAS).

The first wireless communication circuit 21 is a device that includes a first antenna 22 and is configured to perform wireless communication with a first wireless communication terminal 51 through the first antenna 22. Examples of the first wireless communication terminal 51 include the FOB key of the user of the vehicle 1 and a smartphone. The FOB key may be read as another term such as a smart key, an electronic key, a portable key, or a badge. Examples of the wireless communication between the first wireless communication circuit 21 and the first wireless communication terminal 51 include low frequency (LF), radio frequency (RF), and Bluetooth (registered trademark).

The second wireless communication circuit 23 is a device that includes a second antenna 24 and is configured to perform wireless communication with a second wireless communication terminal 52 different from the first wireless communication terminal 51 through the second antenna 24. The second wireless communication terminal 52 may be read as a management terminal. Examples of the management terminal include a PC, a tablet terminal, a smartphone, and the like that are used by the movement authorized person that performs the auto valet parking. Examples of the wireless communication between the second wireless communication circuit 23 and the second wireless communication terminal 52 include cellular communication (for example, long term evolution (LTE), 4G, and 5G), Wi-Fi (registered trademark), and Bluetooth. The second wireless communication circuit 23 and the second wireless communication terminal 52 may communicate with each other via a predetermined server.

When the first wireless communication terminal 51 and the second wireless communication terminal 52 support a common wireless communication method (for example, Bluetooth), the first wireless communication circuit 21 and the second wireless communication circuit 23 may be the same. Alternatively, in this case, the first wireless communication circuit 21 and the second wireless communication circuit 23 may be configured as one wireless communication circuit.

The control device 20 is a device that controls a behavior of the vehicle 1 such as forward movement, backward movement, turn, and stop. The control device 20 is coupled to at least the first wireless communication circuit 21 and the second wireless communication circuit 23. The control device 20 has a manual driving mode and the autonomous driving mode.

In the manual driving mode, the control device 20 controls the behavior of the vehicle 1 according to the manual driving performed by an occupant. For example, the control device 20 causes the vehicle 1 to move forward, backward, turn, and stop in accordance with a steering wheel operation, a shift operation, an accelerator operation, and a brake operation performed by the occupant.

In the autonomous driving mode, the control device 20 autonomously controls the behavior of the vehicle 1 using the recognition result of the surroundings of the vehicle 1 obtained by the environment recognition device 15, and moves the vehicle 1 to the destination. In the autonomous driving mode, a person may or may not board the vehicle 1.

In the manual driving mode, when a predetermined relationship with the first wireless communication terminal 51 is established, the control device 20 may allow the occupant to perform the manual driving. The occupant in this case is, for example, the user of the vehicle 1.

In the manual driving mode, when the predetermined relationship with the first wireless communication terminal 51 is not established, the control device 20 may not allow the occupant to perform the manual driving. The occupant in this case is, for example, a thief.

In the autonomous driving mode, when the predetermined relationship with the first wireless communication terminal 51 is established, the control device 20 may enable transition to the manual driving mode. That is, in this case, the control device 20 may enable the authority transfer.

In the autonomous driving mode, when the predetermined relationship with the first wireless communication terminal 51 is not established, the control device 20 may disable the transition to the manual driving mode. That is, in this case, the control device 20 may disable the authority transfer.

In the autonomous driving mode, when the predetermined relationship with the first wireless communication terminal 51 is not established, the control device 20 may allow the transition to the manual driving mode by a predetermined operation of the second wireless communication terminal 52. That is, even when the predetermined relationship with the first wireless communication terminal 51 is not established, the control device 20 may enable the authority transfer when the predetermined operation is performed in the second wireless communication terminal 52.

The case in which the predetermined relationship with the first wireless communication terminal 51 is established may be a case in which user authentication succeeds for a signal for user authentication received by the first wireless communication circuit 21 from the first wireless communication terminal 51.

The case in which the predetermined relationship with the first wireless communication terminal 51 is not established may be a case in which the user authentication fails for the signal for user authentication received by the first wireless communication circuit 21 from the first wireless communication terminal 51, or a case in which the first wireless communication circuit 21 does not receive the signal for user authentication.

The predetermined operation of the second wireless communication terminal 52 may be an operation of the second wireless communication terminal 52 by a person (that is, a movement authorized person) who has accepted the movement authority of the vehicle 1 without receiving the first wireless communication terminal 51 from the user. For example, the movement authorized person operates the second wireless communication terminal 52 to transmit the signal for user authentication from the second wireless communication terminal 52. The second wireless communication circuit 23 may receive the signal for user authentication transmitted from the second wireless communication terminal 52, and the control device 20 may perform the user authentication on the signal for user authentication received by the second wireless communication circuit 23.

The opening and closing portion 40 of the vehicle is openable and closable, and the occupant can open the opening and closing portion 40 to enter and exit the vehicle 1. The opening and closing portion 40 may be read as a door of the vehicle 1. The opening and closing portion 40 may include a lock circuit 41 that locks opening of the opening and closing portion 40.

In the autonomous driving mode, when the predetermined relationship with the first wireless communication terminal 51 is established, the control device 20 may allow the opening and closing portion 40 to be opened and closed. Accordingly, the user carrying the first wireless communication terminal 51 can open the opening and closing portion 40.

In the autonomous driving mode, when the predetermined relationship with the first wireless communication terminal 51 is not established, the control device 20 may not open the opening and closing portion 40 by the lock circuit 41. Accordingly, the thief who does not have the first wireless communication terminal 51 cannot open the opening and closing portion 40.

In the autonomous driving mode, when the predetermined relationship with the first wireless communication terminal 51 is not established, the control device 20 may allow the opening and closing portion 40 to be opened and closed by the predetermined operation of the second wireless communication terminal 52. Accordingly, the movement authorized person can open the opening and closing portion 40 by operating the second wireless communication terminal 52.

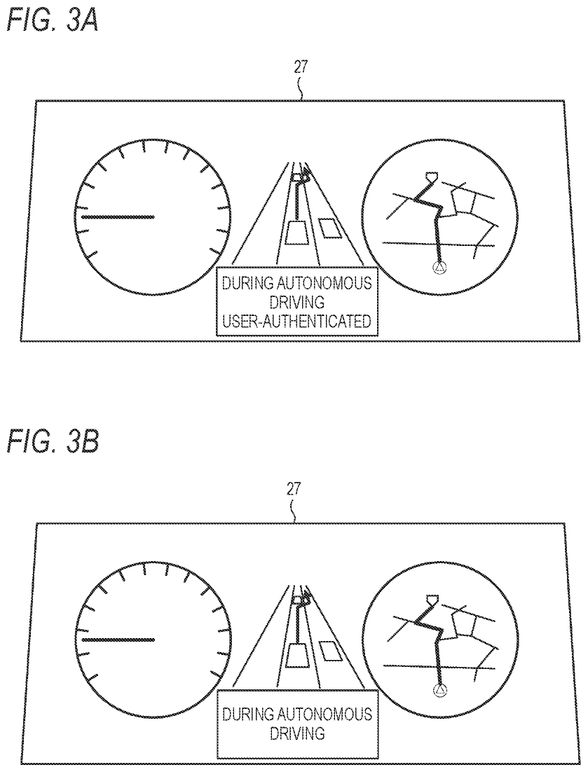

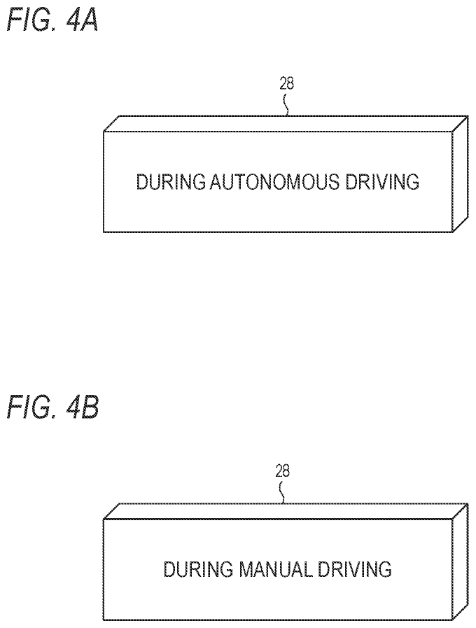

A display circuit displays the information. The display circuit includes at least one of the in-vehicle display circuit 27 illustrated in FIGS. 1, 3A, and 3B and performing display toward an inside of the vehicle 1, and the out-of-vehicle display circuit 28 illustrated in FIGS. 1, 4A, and 4B and performing display toward an outside of the vehicle 1. Examples of the in-vehicle display circuit 27 include an instrument panel (see FIGS. 3A and 3B), a liquid crystal display, an organic EL display, and an LED. Examples of the out-of-vehicle display circuit 28 include a liquid crystal display, an organic EL display, and an LED. Although the out-of-vehicle display circuit 28 is provided on a roof of the vehicle 1 in FIG. 1, the out-of-vehicle display circuit 28 may be provided at a location different from the roof of the vehicle 1. For example, the out-of-vehicle display circuit 28 may be provided on a front bumper of the vehicle 1, a headlight of the vehicle 1, or the like.

In the autonomous driving mode, when the predetermined relationship with the first wireless communication terminal 51 is established, the display circuit performs a first display. For example, as illustrated in FIG. 3A, the in-vehicle display circuit 27 displays, as the first display, information indicating that the user authentication is completed. Accordingly, the user having the first wireless communication terminal 51 can recognize that the authority transfer is possible by viewing the first display of the in-vehicle display circuit 27. The out-of-vehicle display circuit 28 may perform the first display.

In the autonomous driving mode, when the predetermined relationship with the first wireless communication terminal 51 is not established, the display circuit performs a second display. For example, as illustrated in FIG. 3B, the in-vehicle display circuit 27 does not display, as the second display, information related to the user authentication. Accordingly, the thief cannot recognize whether the authority transfer is possible even when viewing the second display of the in-vehicle display circuit 27. The out-of-vehicle display circuit 28 may perform the second display.

In the autonomous driving mode, in the case in which the predetermined relationship with the first wireless communication terminal 51 is not established and the opening and closing portion 40 is openable and closable by the predetermined operation of the second wireless communication terminal 52, the display circuit performs a third display different from the first display. For example, as illustrated in FIG. 3B, the in-vehicle display circuit 27 does not display, as the third display, information related to the user authentication. The second display and the third display may be the same. Accordingly, even when the authority transfer of the vehicle 1 is possible by the predetermined operation of the second wireless communication terminal 52, the thief cannot recognize whether the authority transfer is possible even when viewing the third display of the in-vehicle display circuit 27. The out-of-vehicle display circuit 28 may perform the third display.

The second wireless communication terminal 52 includes a display circuit 53 that displays the information. Examples of the display circuit 53 include a liquid crystal display and an organic EL display.

When the vehicle 1 can transition to the manual driving mode by the predetermined operation of the second wireless communication terminal 52, the display circuit 53 of the second wireless communication terminal 52 may display that the vehicle 1 can transition to the manual driving mode. When the opening and closing portion 40 of the vehicle 1 is openable and closable, the display circuit 53 of the second wireless communication terminal 52 may display information indicating that the opening and closing portion 40 of the vehicle 1 is openable and closable. Accordingly, as described above, even when the information related to the user authentication is not displayed on the in-vehicle display circuit 27, the movement authorized person can recognize that the authority transfer is possible by the display on the display circuit 53 of the second wireless communication terminal 52.

The engine control device 29 controls a behavior of the engine in the vehicle 1. In the case of the manual driving mode, the engine control device 29 may control the behavior of the engine (that is, forward or backward movement of the vehicle 1) in accordance with a shift operation and an accelerator operation of the occupant. In the case of the autonomous driving mode, the engine control device 29 controls the behavior of the engine in accordance with autonomous control of the control device 20. When the vehicle 1 is an electric vehicle or a hybrid vehicle, the engine may be read as a motor.

The brake control device 30 controls a behavior of a brake in the vehicle 1. In the case of the manual driving mode, the engine control device 29 may control the behavior of the brake (that is, a stop of the vehicle 1) according to the brake operation of the occupant. In the case of the autonomous driving mode, the brake control device 30 may control the behavior of the brake in accordance with the autonomous control performed by the control device 20.

The EPS control device 31 controls a behavior of steering of the vehicle 1. In the manual driving mode, the EPS control device 31 may control the behavior of the steering (that is, a turn of the vehicle 1) according to the steering wheel operation of the occupant. In the case of the autonomous driving mode, the EPS control device 31 may control the behavior of the steering in accordance with the autonomous control performed by the control device 20.

<Operation of Vehicle>

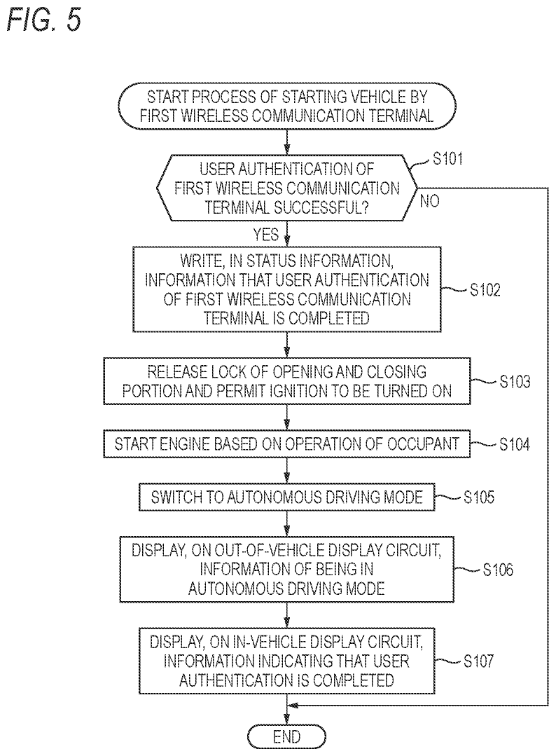

An example of a process performed by the vehicle 1 and the control device 20 according to the first embodiment will be described with reference to flowcharts illustrated in FIGS. 5 to 8.

FIG. 5 is a flowchart illustrating an example of a process of starting the vehicle 1 by the first wireless communication terminal 51 according to the first embodiment. The process may be started when the first wireless communication terminal 51 of the user transmits the signal for user authentication and the first wireless communication circuit 21 receives the signal for user authentication.

In S101, the control device 20 performs the user authentication on the signal for user authentication received from the first wireless communication terminal 51, and determines whether the user authentication is successful.

When it is determined in S101 that the user authentication fails (S101: NO), the control device 20 ends the process.

When it is determined in S101 that the user authentication is successful (S101: YES), in S102, the control device 20 writes, in status information for holding a status related to authentication, information that the user authentication of the first wireless communication terminal 51 is completed.

In S103, the control device 20 releases a lock of the opening and closing portion 40 through the lock circuit 41 and permits an ignition to be turned on.

In S104, in a case in which the user boarding the vehicle 1 performs an operation of starting the engine, the control device 20 starts the engine.

In S105, the control device 20 switches to the autonomous driving mode.

In S106, as illustrated in FIG. 4A, the control device 20 displays, on the out-of-vehicle display circuit 28, information indicating that the vehicle 1 is behaving in the autonomous driving mode. Accordingly, a person and another vehicle near the vehicle 1 can recognize that the vehicle 1 is being driven autonomously.

In S107, as illustrated in FIG. 3A, the control device 20 displays, on the in-vehicle display circuit 27, information indicating that the user authentication is completed. Accordingly, the occupant (user) of the vehicle 1 can recognize that the authority transfer is possible. Further, the control device 20 ends the process.

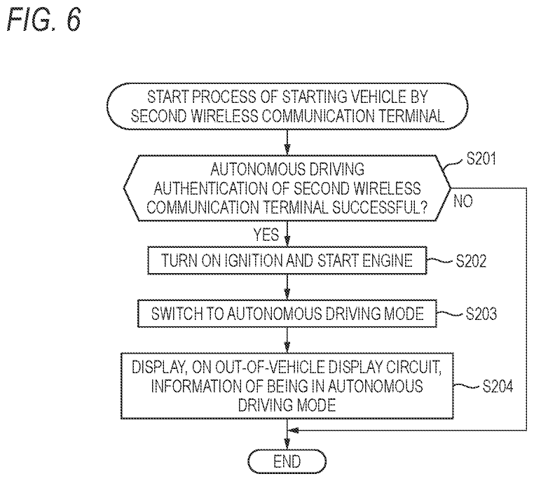

FIG. 6 is a flowchart illustrating an example of a process of starting the vehicle 1 by the second wireless communication terminal 52 according to the first embodiment. The process may be started, for example, when the second wireless communication terminal 52 operated by the movement authorized person transmits a signal for autonomous driving authentication and the second wireless communication circuit 23 receives the signal for autonomous driving authentication. For example, when the unmanned vehicle 1 is autonomously moved to the parking position in the auto valet parking, the movement authorized person may perform an operation related to the autonomous driving authentication on the second wireless communication terminal 52.

In S201, the control device 20 performs authentication on the signal for autonomous driving authentication received from the second wireless communication terminal 52, and determines whether the autonomous driving authentication is successful.

When it is determined in S201 that the autonomous driving authentication fails (S201: NO), the control device 20 ends the process.

When it is determined in S201 that the autonomous driving authentication is successful (S201: YES), the control device 20 turns on the ignition and starts the engine in S202. At this time, the user or the movement authorized person may not be present in the vehicle 1. That is, the vehicle 1 may be unmanned.

In S203, the control device 20 switches to the autonomous driving mode.

In S204, as illustrated in FIG. 4A, the control device 20 displays, on the out-of-vehicle display circuit 28, information indicating that the vehicle 1 is behaving in the autonomous driving mode. Accordingly, a person and another vehicle near the vehicle 1 can recognize that the vehicle 1 is being driven autonomously. Further, the control device 20 ends the process.

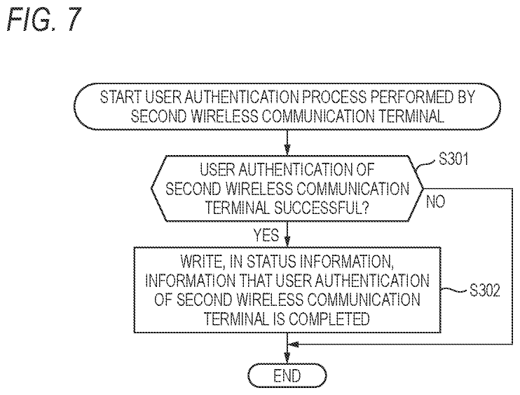

FIG. 7 is a flowchart illustrating an example of a remote user authentication process performed by the second wireless communication terminal 52 according to the first embodiment. The process may be started, for example, when the second wireless communication terminal 52 operated by the movement authorized person transmits the signal for user authentication and the second wireless communication circuit 23 receives the signal for signal for user authentication. For example, when a situation in which the manual driving of the vehicle 1 is necessary occurs in the auto valet parking, the movement authorized person may perform an operation related to the user authentication on the second wireless communication terminal 52. Alternatively, when the first wireless communication terminal 51 of the user boarding the vehicle 1 is damaged or lost, the movement authorized person may perform the operation related to the user authentication on the second wireless communication terminal 52.

In S301, the control device 20 performs authentication on the signal for user authentication received from the second wireless communication terminal 52, and determines whether the user authentication is successful.

When it is determined in S301 that the user authentication fails (S301: NO), the control device 20 ends the process.

When it is determined in S301 that the user authentication is successful (S301: YES), the control device 20 writes, in the status information, information that the user authentication of the second wireless communication terminal 52 is completed. Here, as illustrated in FIG. 3B, the control device 20 does not display, on the in-vehicle display circuit 27, information indicating that the user authentication is completed. This is because the thief who gets into the unmanned vehicle 1 knows that the authority transfer is possible if the information indicating that the user authentication is completed is displayed on the in-vehicle display circuit 27. Further, the control device 20 ends the process.

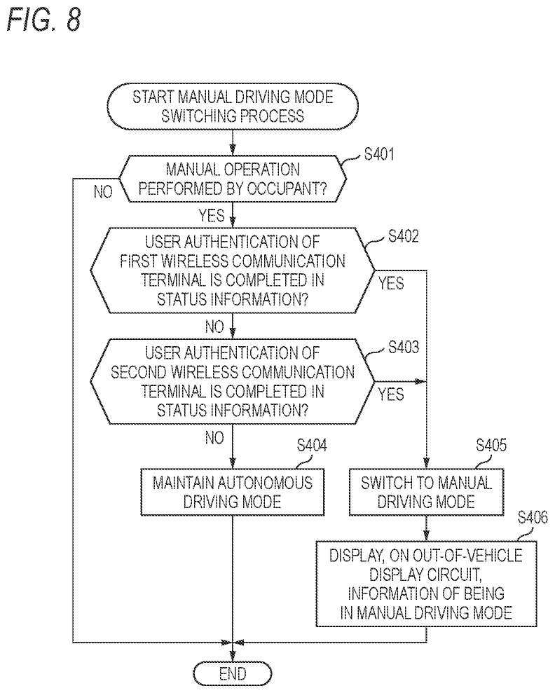

FIG. 8 is a flowchart illustrating an example of a manual driving mode switching process according to the first embodiment.

In S401, the control device 20 determines whether a manual operation is performed by the occupant. Here, the occupant may be any of the user of the vehicle 1, the movement authorized person, and the thief. As described above, the manual operation may be the steering wheel operation, the accelerator operation, the brake operation, or the like.

When it is determined in S401 that the manual operation is not performed by the occupant (S401: NO), the control device 20 ends the process.

When it is determined in S401 that the manual operation is performed by the occupant (S401: YES), in S402, the control device 20 determines whether the user authentication of the first wireless communication terminal 51 is completed in the status information.

When it is determined in S402 that the user authentication of the first wireless communication terminal 51 is completed in the status information (S402: NO), in S403, the control device 20 determines whether the user authentication of the second wireless communication terminal 52 is completed in the status information.

When it is determined in S403 that the user authentication of the second wireless communication terminal 52 is not completed in the status information (S403: NO), in S404, the control device 20 ends the processing while maintaining the autonomous driving mode. For example, in a case in which the occupant is the thief, even if the manual operation is performed, both the determinations of S401 and S402 are NO, and thus the autonomous driving mode is maintained in this manner. Accordingly, the thief can be prevented from stealing the vehicle 1 by transferring the authority.

When it is determined in S402 that the user authentication of the first wireless communication terminal 51 is completed in the status information (S402: YES), or when it is determined in S402 that the user authentication of the second wireless communication terminal 52 is completed in the status information (S403: YES), in S405, the control device 20 switches to the manual driving mode. For example, in a case in which the occupant is the user or the movement authorized person, the manual operation causes the determination in S402 or S403 to be YES, and thus the mode is switched to the manual driving mode in this manner. Accordingly, the user or the movement authorized person of the vehicle 1 can perform the authority transfer to switch to the manual driving.

In S406, as illustrated in FIG. 4B, the control device 20 displays, on the out-of-vehicle display circuit 28, information indicating that the mode is the manual driving mode. Accordingly, a person and another vehicle near the vehicle 1 can recognize that the vehicle 1 is being driven manually. Further, the control device 20 ends the process.

The first embodiment has been described above.

According to the first embodiment, the user carrying the first wireless communication terminal 51 and the movement authorized person who can perform the user authentication through the second wireless communication terminal 52 can switch the autonomous driving to the manual driving. On the other hand, even if the thief who does not carry the first wireless communication terminal 51 and does not have the operation authority of the second wireless communication terminal 52 gets into the unmanned vehicle 1, the thief cannot switch the autonomous driving to the manual driving. Accordingly, according to the first embodiment, the user and the movement authorized person can appropriately perform the autonomous driving and the manual driving of the vehicle 1 while preventing the vehicle 1 from being stolen.

### APPENDIX REGARDING FIRST EMBODIMENT

### Appendix 1

A vehicle including a first wireless communication circuit configured to communicate with a first wireless communication terminal, and a second wireless communication circuit configured to communicate with a second wireless communication terminal different from the first wireless communication terminal, the vehicle including:

a manual driving mode in which an occupant of the vehicle manually drives the vehicle, and an autonomous driving mode in which the occupant is capable of autonomously moving the vehicle without boarding the vehicle, in which

in the manual driving mode, when a predetermined relationship with the first wireless communication terminal is established, manual driving by the occupant is possible,

in the manual driving mode, when the predetermined relationship with the first wireless communication terminal is not established, the manual driving by the occupant is impossible,

in the autonomous driving mode, when the predetermined relationship with the first wireless communication terminal is established, transition to the manual driving mode is possible,

in the autonomous driving mode, when the predetermined relationship with the first wireless communication terminal is not established, the transition to the manual driving mode is impossible, and

in the autonomous driving mode, when the predetermined relationship with the first wireless communication terminal is not established, the transition to the manual driving mode is possible by a predetermined operation of the second wireless communication terminal.

### Appendix 2

The vehicle according to Appendix 1, further including:

a control circuit, in which

the control circuit is coupled to at least the first wireless communication circuit and the second wireless communication circuit.

### Appendix 3

The vehicle according to Appendix 1 or 2, further including:

an opening and closing portion that allows the occupant to enter and exit and includes a lock circuit, in which

in the autonomous driving mode, when the predetermined relationship with the first wireless communication terminal is established, the opening and closing portion is openable and closable,

in the autonomous driving mode, when the predetermined relationship with the first wireless communication terminal is not established, the opening and closing portion is not opened by the lock circuit, and

in the autonomous driving mode, when the predetermined relationship with the first wireless communication terminal is not established, the opening and closing portion is openable and closable by the predetermined operation of the second wireless communication terminal.

### Appendix 4

The vehicle according to Appendix 3, further including:

a display circuit, in which

in the autonomous driving mode, when the predetermined relationship with the first wireless communication terminal is established, the display circuit performs a first display,

in the autonomous driving mode, when the predetermined relationship with the first wireless communication terminal is not established, the display circuit performs a second display, and

in the autonomous driving mode, in a case in which the predetermined relationship with the first wireless communication terminal is not established, when the opening and closing portion is openable and closable by the predetermined operation of the second wireless communication terminal, the display circuit performs a third display different from the first display.

### Appendix 5

The vehicle according to Appendix 4, in which

the second display and the third display are the same.

### Appendix 6

The vehicle according to Appendix 4 or 5, in which

the display circuit is an in-vehicle display circuit that performs a display toward an inside of the vehicle and/or an out-of-vehicle display circuit that performs a display toward an outside of the vehicle.

### Appendix 7

The vehicle according to any one of Appendixes 1 to 6, in which

the second wireless communication terminal includes a display circuit, and

when the vehicle is capable of transitioning to the manual driving mode by the predetermined operation of the second wireless communication terminal, the display circuit of the second wireless communication terminal displays that the vehicle is capable of transitioning to the manual driving mode.

### Appendix 8

The vehicle according to any one of Appendixes 1 to 6, further including:

a vehicle body, and

a first wheel and a second wheel which are coupled to the vehicle body, in which

the vehicle is movable using the first wheel and the second wheel.

### Appendix 9

The vehicle according to any one of Appendixes 1 to 8, in which

the first wireless communication circuit includes a first antenna, and

the second wireless communication circuit includes a second antenna.

### Appendix 10

The vehicle according to any one of Appendixes 1 to 9, in which

the first wireless communication circuit and the second wireless communication circuit are the same.

### Appendix 11

A control device mountable on a vehicle including a first wireless communication circuit configured to communicate with a first wireless communication terminal, and a second wireless communication circuit configured to communicate with a second wireless communication terminal different from the first wireless communication terminal, the control device including:

a manual driving mode in which an occupant of the vehicle manually drives the vehicle, and an autonomous driving mode in which the occupant is capable of autonomously moving the vehicle without boarding the vehicle, in which

in the manual driving mode, when a predetermined relationship with the first wireless communication terminal is established, manual driving by the occupant is possible,

in the manual driving mode, when the predetermined relationship with the first wireless communication terminal is not established, the manual driving by the occupant is impossible,

in the autonomous driving mode, when the predetermined relationship with the first wireless communication terminal is established, transition to the manual driving mode is possible,

in the autonomous driving mode, when the predetermined relationship with the first wireless communication terminal is not established, the transition to the manual driving mode is impossible, and

in the autonomous driving mode, when the predetermined relationship with the first wireless communication terminal is not established, the transition to the manual driving mode is possible by a predetermined operation of the second wireless communication terminal.

### Appendix 12

The control device according to Appendix 11, further including:

a control circuit, in which

the control circuit is coupled to at least the first wireless communication circuit and the second wireless communication circuit.

### Appendix 13

The control device according to Appendix 11 or 12, in which

the vehicle further includes an opening and closing portion that allows the occupant to enter and exit and includes a lock circuit,

in the autonomous driving mode, when the predetermined relationship with the first wireless communication terminal is established, the opening and closing portion is openable and closable,

in the autonomous driving mode, when the predetermined relationship with the first wireless communication terminal is not established, the opening and closing portion is not opened by the lock circuit, and

in the autonomous driving mode, when the predetermined relationship with the first wireless communication terminal is not established, the opening and closing portion is openable and closable by the predetermined operation of the second wireless communication terminal.

### Appendix 14

The control device according to Appendix 13, in which

the vehicle further includes a display circuit,

in the autonomous driving mode, when the predetermined relationship with the first wireless communication terminal is established, the display circuit performs a first display,

in the autonomous driving mode, when the predetermined relationship with the first wireless communication terminal is not established, the display circuit performs a second display, and

in the autonomous driving mode, in a case in which the predetermined relationship with the first wireless communication terminal is not established, when the opening and closing portion is openable and closable by the predetermined operation of the second wireless communication terminal, the display circuit performs a third display different from the first display.

### Appendix 15

The control device according to Appendix 14, in which

the second display and the third display are the same.

### Appendix 16

The control device according to Appendix 14 or 15, in which

the display circuit is an in-vehicle display circuit that performs a display toward an inside of the vehicle and/or an out-of-vehicle display circuit that performs a display toward an outside of the vehicle.

### Appendix 17

The control device according to any one of Appendixes 11 to 16, in which

the second wireless communication terminal includes a display circuit, and

when the vehicle is capable of transitioning to the manual driving mode by the predetermined operation of the second wireless communication terminal, the display circuit of the second wireless communication terminal displays that the vehicle is capable of transitioning to the manual driving mode.

### Appendix 18

The control device according to any one of Appendixes 11 to 16, in which

the vehicle further includes
a vehicle body, and
a first wheel and a second wheel which are coupled to the vehicle body, and

the vehicle is movable using the first wheel and the second wheel.

### Appendix 19

The control device according to any one of Appendixes 11 to 18, in which

the first wireless communication circuit of the vehicle includes a first antenna, and

the second wireless communication circuit of the vehicle includes a second antenna.

### Appendix 20

The control device according to any one of Appendixes 11 to 19, in which

the first wireless communication circuit of the vehicle and the second wireless communication circuit of the vehicle are the same.

### Second Embodiment

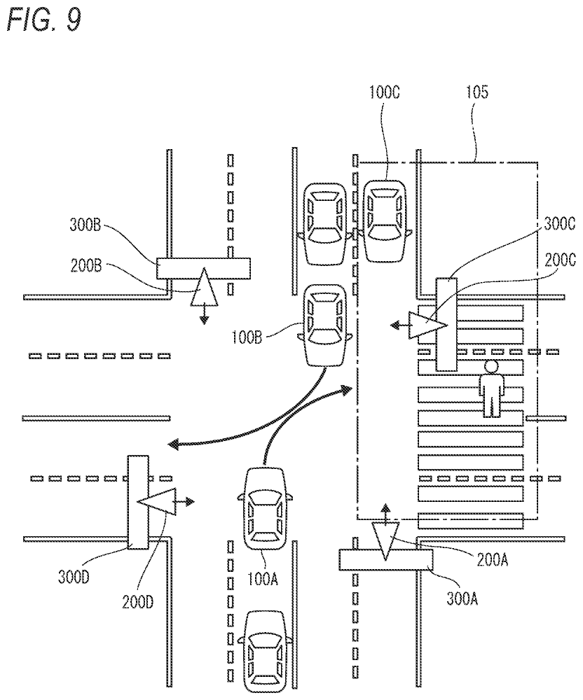

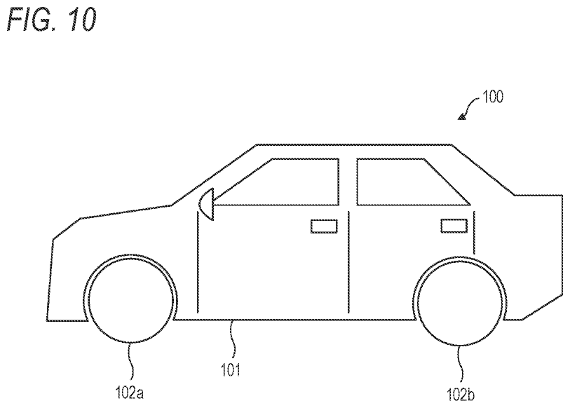

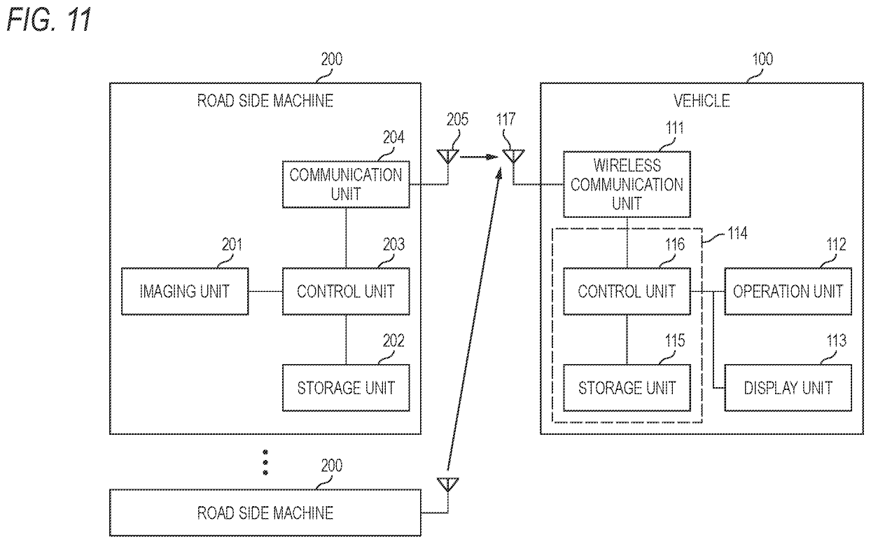

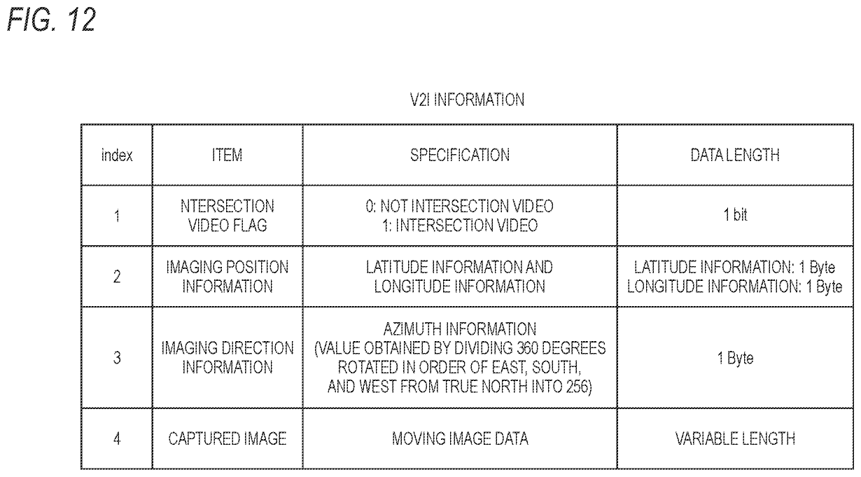

FIG. 9 is a schematic diagram illustrating a situation in which a vehicle 100A according to a second embodiment turns right at an intersection. FIG. 10 is a schematic diagram illustrating an example of a configuration of the vehicle 100A according to the second embodiment. FIG. 11 is a block diagram illustrating an example of configurations of a road side machine 200 and the vehicle 100A according to the second embodiment. FIG. 12 is a diagram illustrating an example of a format of the V2I information according to the second embodiment. In a description of FIG. 9, when road side machines are distinguished, reference signs are represented by a combination of numerals and alphabets as in road side machines 200A, 200B, and the like, and when the road side machines are not distinguished, the reference signs are represented by only numerals as in the road side machine 200. A method for expressing the reference numerals is the same for a vehicle and a traffic signal.

As illustrated in FIG. 9, for a driver of the vehicle 100A that turns right at the intersection, an oncoming lane and an area around the oncoming lane may be a blind spot. Hereinafter, an area that may be a blind spot for the driver of the vehicle 100A that turns right at the intersection is referred to as a blind area 105. In the second embodiment, the road side machine 200 and the vehicle 100 which allow the driver of the vehicle 100A that turns right to recognize the situation of the blind area 105 will be described.

<Road Side Machine>

As illustrated in FIG. 9, the road side machines 200A, 200B, 200C, and 200D are respectively provided in traffic signals 300A, 300B, 300C, and 300D provided at the intersections. However, the road side machine 200 is not limited to being provided in the traffic signals 300A, 300B, 300C, and 300D, and may be provided in another structure such as a road sign or an electric pole provided at the intersection. Alternatively, the road side machine 200 may be provided in a predetermined pole provided at the intersection.

In the description of FIG. 9, for the sake of convenience, an upper direction of the drawing is north, a lower direction of the drawing is south, a right direction of the drawing is east, and a left direction of the drawing is west.

In FIG. 9, at the intersection, the road side machine 200A is provided in the traffic signal 300A that controls traffic of a vehicle 100B traveling from the north to the south, the road side machine 200B is provided in the traffic signal 300B that controls traffic of the vehicle 100A traveling from the south to the north, the road side machine 200C is provided in the traffic signal 300C that controls traffic of a vehicle (not shown) traveling from the west to the east, and the road side machine 200D is provided in the traffic signal 300D that controls traffic of the vehicle (not shown) traveling from east to the west.

Next, the configuration of the road side machine 200 will be described with reference to FIG. 11. As illustrated in FIG. 11, the road side machine 200 includes an imaging unit 201, a storage unit 202, a control unit 203, and a communication unit 204.

The imaging unit 201 is configured to image the vehicle 100 in a predetermined imaging direction on a road. For example, the imaging unit 201 of the road side machine 200A illustrated in FIG. 9 is configured to capture images of vehicles 100B and 100C traveling from the north to the south. That is, the imaging direction of the imaging unit 201 of the road side machine 200A is a northward direction. The imaging unit 201 captures an image in the imaging direction and generates a captured image. For example, in the captured image captured by the imaging unit 201 of the road side machine 200A illustrated in FIG. 9, a lane from the north to the south, the vehicle 100B traveling in the lane, and the like are captured. The captured image may be either a moving image or a still image.

The storage unit 202 retains data, a computer program, and the like handled by the road side machine 200. The storage unit 202 may be configured as a read-only memory (ROM), a random access memory (RAM), a flash memory, or a combination thereof. The storage unit 202 retains in advance imaging position information indicating an installation position of the imaging unit 201 and imaging direction information indicating the imaging direction of the imaging unit 201. The imaging position information may be represented by longitude and latitude. The imaging direction information may be represented by an azimuth. Alternatively, the imaging direction information may be represented by a 360 degree azimuth in which the north is 0 degrees (or 360 degrees), the east is 90 degrees, the south is 180 degrees, and the west is 270 degrees.

The control unit 203 achieves a function of the road side machine 200 according to the present embodiment by reading and executing the data and the computer program retained in the storage unit 202. The control unit 203 may be read as another term such as a central processing unit (CPU), a processor, a controller, or an arithmetic circuit. The control unit 203 outputs the imaging position information and the imaging direction information retained in the storage unit 202 and the captured image generated by the imaging unit 201 to the communication unit 204.

The communication unit 204 outputs the imaging position information, the imaging direction information, and the captured image as a communication signal. The communication unit 204 may include an antenna 205 that outputs the communication signal as a wireless communication signal. In this case, the communication unit 204 outputs the wireless communication signal through the antenna 205. Alternatively, the communication unit 204 may output the communication signal to a wired communication cable connected to a cellular wireless base station. In this case, the wireless base station may convert the communication signal input from the communication unit 204 via the communication cable into the wireless communication signal and output the wireless communication signal.

The communication unit 204 may be capable of V2X communication. The communication unit 204 may broadcast the wireless communication signal to surroundings as vehicle to infrastructure (V2I) communication in the V2X communication. The V2X communication includes vehicle to vehicle (V2V) communication, vehicle to pedestrian (V2P) communication, and vehicle to network (V2N) communication, in addition to the V2I communication. Examples of a V2X communication method include dedicated short range communications (DSRC) and cellular-V2x (C-V2X). The V2X communication method may support 4G or 5G.

In the V2I communication according to the present embodiment, the V2I information may be transmitted based on a data format illustrated in FIG. 12. FIG. 12 is a diagram illustrating the example of the data format of the V2I information according to the second embodiment. As illustrated in FIG. 12, the V2I information may include, as data items, an intersection video flag, imaging position information, imaging direction information, and the captured image.

The intersection video flag is a flag indicating whether the captured image in the V2I information is a video of the intersection. When the intersection video flag is 0, the flag may indicate that the captured image is not the video of the intersection, and when the intersection video flag is 1, the flag may indicate that the captured image is the video of the intersection. A data length of the intersection video flag may be 1 bit.

The imaging position information is information indicating an imaging position of the captured image. The imaging position information may include latitude information indicating longitude of the imaging position and longitude information indicating latitude of the imaging position. A data length of each of the latitude information and the longitude information may be 1 Byte.

The imaging direction information is information indicating the imaging direction of the captured image. The imaging direction information may include azimuth information. The azimuth information may be a value obtained by dividing 360 degrees rotated in an order of the east, the south, and the west from true north into 256. In this case, a data length of the imaging direction information may be 1 Byte.

The captured image is data of an image captured in the direction indicated by the imaging direction information from the position indicated by the imaging position information. The captured image may be moving image data. However, the captured image may be still image data. A data length of the captured image may be a variable length.

<Vehicle>

As illustrated in FIG. 10, the vehicle 100 includes first wheels 102a, second wheels 102b, and a vehicle body 101 coupled to the first wheels 102a and the second wheels 102b. The vehicle 100 is movable using the first wheels 102a and the second wheels 102b. The first wheels 102a may be front wheels of the vehicle 100, and the second wheels 102b may be rear wheels of the vehicle 100. In the present embodiment, a case in which the vehicle 100 includes four wheels will be described, but the vehicle 100 may include two wheels, three wheels, or five or more wheels. As illustrated in FIG. 11, the vehicle 100 includes a wireless communication unit 111, an operation unit 112, a display unit 113, and a control device 114.

The wireless communication unit 111 is configured to receive the position (that is, the imaging position information) of the imaging unit 201 provided in the road side machine 200, the imaging direction (that is, the imaging direction information) of the imaging unit 201, and the image (that is, the captured image) captured by the imaging unit 201. For example, the wireless communication unit 111 includes an antenna 117, and receives the wireless communication signal including the imaging position information, the imaging direction information, and the captured image transmitted from the road side machine 200 through the antenna 117. The wireless communication signal may be the V2I information as illustrated in FIG. 12.

The operation unit 112 receives an operation of the vehicle 100 from a driver. Examples of the operation of the vehicle 100 include a steering wheel operation, an accelerator operation, a brake operation, and a winker operation.

The display unit 113 is provided in the vehicle 100 and displays various types of information toward the driver. Examples of the display unit 113 include a liquid crystal display and an organic EL display.

The control device 114 is a device that controls a function according to the present embodiment, and includes a storage unit 115 and a control unit 116. The control device 114 may be mounted on the vehicle 100 as one or a plurality of electronic control units (ECU).

The storage unit 115 retains data, a computer program, and the like handled by the control device 114. The storage unit 115 may be configured as a ROM, a RAM, a flash memory, or a combination thereof.

The control unit 116 achieves a function of the vehicle 100 according to the present embodiment by reading and executing the data and the computer program retained in the storage unit 115. The control unit 116 may be read as another term such as a CPU, a processor, a controller, or an arithmetic circuit.

The control device 114 displays, on the display unit 113, the captured image based on the imaging position information and the imaging direction information. For example, when the operation unit 112 receives a predetermined operation, the control device 114 displays the captured image on the display unit 113 based on the imaging position information and the imaging direction information. In this case, the control device 114 may display, on the display unit 113, a captured image in which the imaging direction information is common to a direction of the vehicle 100. When there are a plurality of captured images in which the imaging direction information is common to the direction of the vehicle 100, the control device 114 may display, on the display unit 113, a captured image in which the imaging position information is closest to the position of the vehicle 100.

The case in which the operation unit 112 receives the predetermined operation may be a case in which the operation unit 112 receives an operation of a right turn. Examples of the operation of the right turn in the operation unit 112 include an operation of turning on a winker which turns right and an operation of rotating a steering wheel to the right. When a navigation device (not shown) of the vehicle 100 provides guidance to start the right turn, the control device 114 may display the captured image on the display unit 113 based on the imaging position information and the imaging direction information.

For example, in FIG. 9, the vehicle 100A is traveling from the south to the north (that is, a direction of the vehicle 100A is a northward direction) and is starting the right turn at the intersection. The imaging direction information of the road side machine 200A among the road side machines 200A, 200B, 200C, and 200D is the northward direction. Therefore, the vehicle 100A may display, on the display unit 113, the captured image of the imaging unit 201 of the road side machine 200A that transmits the imaging direction information, that is, the “northward direction” common to the “northward” direction of the vehicle 100A. In this captured image, as illustrated in FIG. 9, a situation in the blind area 105 of the driver of the vehicle 100A is captured. For example, in the captured image, the vehicle 100C present in the blind area 105 is captured. Accordingly, the driver can avoid a collision with the vehicle 100C by recognizing, from the captured image displayed on the display unit 113, that the vehicle 100C present in the blind area 105 enters the intersection, and temporarily stopping a progress of the right turn.

<Process Flow>

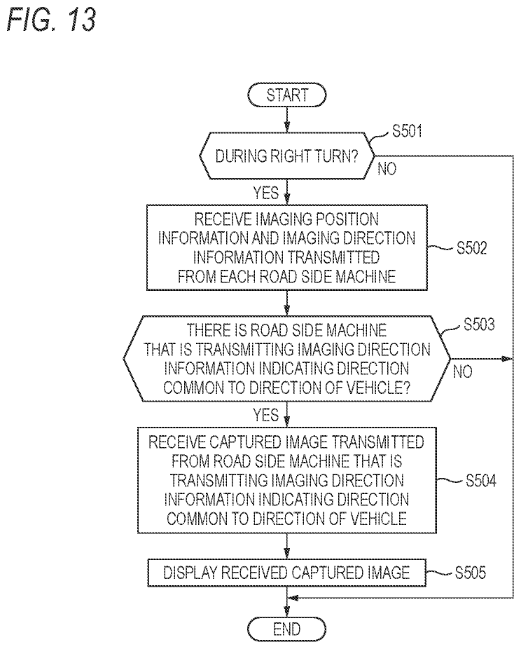

FIG. 13 is a flowchart illustrating an example of a driving assist process according to the second embodiment. The process may be repeatedly executed during an operation of the vehicle 100.

In S501, the control device 114 determines whether the vehicle 100 is turning right. The term “turning right” may be a period from a right-turn start timing to a right-turn end timing. The right-turn start timing may be a timing at which a winker operation of the right turn is turned on, a timing at which the steering wheel is rotated to the right, or a timing at which the guidance of the right turn is started in the navigation device. The right-turn end timing may be a timing at which the winker operation of the right turn is turned off, a timing at which the steering wheel rotated to the right is returned to an original position, or a timing at which the guidance of the right turn is ended in the navigation device.

When it is determined in S501 that the vehicle 100 is not turning right (S501: NO), the process is ended. When it is determined in S501 that the vehicle 100 is turning right (S501: YES), a process of S502 is executed.

In S502, the wireless communication unit 111 receives the imaging position information and the imaging direction information (that is, the V2I information) transmitted from each road side machine 200 by a broadcast as the V2I communication.

In S503, the control device 114 determines whether there is the road side machine 200 that is transmitting the imaging direction information common to the direction of the vehicle 100 in the imaging direction information received in S502.

When it is determined in S503 that there is no road side machine 200 that is transmitting the imaging direction information common to the direction of the vehicle 100 (S503: NO), the process is ended.

When it is determined in S503 that there is the road side machine 200 that is transmitting the imaging direction information common to the direction of the vehicle 100 (S503: YES), a process of S504 is executed.

In S504, the wireless communication unit 111 receives the captured image (that is, the V2I information) transmitted as the V2I communication from the road side machine 200 that is transmitting the imaging direction information common to the direction of the vehicle 100.

In S505, the display unit 113 displays the captured image received in S504.

According to the above-described process, it is possible to automatically select the captured image in which the situation in the blind area 105 of the driver of the vehicle 100 that is turning right is imaged from the captured images transmitted from a plurality of imaging units 201 set at the intersection, and to display the captured image on the display unit 113. Accordingly, the driver can recognize an object (for example, another vehicle, a pedestrian, a bicycle, an object dropped from a truck, or the like) that may be present in the blind area 105, and can safely turn right.

<Display Example>

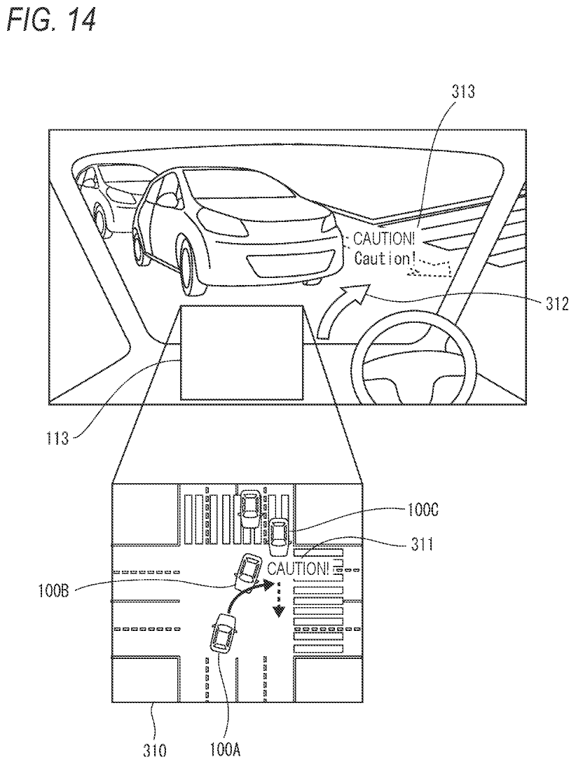

FIG. 14 is a schematic diagram illustrating an example of a display of the captured image on the display unit 113.

As illustrated in FIG. 14, the control device 114 of the vehicle 100A that is turning right may display, on the display unit 113, a captured image 310 received from the road side machine 200A. Accordingly, the driver can recognize the situation of the blind area 105 from the captured image 310 displayed on the display unit 113, and can safely turn right. In FIG. 14, the captured image 310 obtained by observing the intersection from above is illustrated as an example, but the captured image 310 is not limited thereto. For example, the captured image 310 may be an image obtained by looking down in a direction facing the traffic signal 300A (for example, looking obliquely downward) from an upper position corresponding to a position of the traffic signal 300A.

In a case in which the vehicle 100C is present in the blind area 105, the control device 114 may display, on the display unit 113, an image 311 that urges caution. Accordingly, the driver can recognize the image 311 that is displayed on the display unit 113 and that urges the caution, and can turn right more safely.

When the vehicle 100C is present in the blind area 105, the control device 114 may display, on a head-up display (HUD), an image 313 that urges the caution together with an arrow 312 guiding the user to turn right. Accordingly, the driver can recognize the image 313 that is displayed on the HUD and urges the caution, and can turn right more safely.

<Modification>

The road side machine 200 may include a predetermined sensor (for example, a sensor that detects an object) different from the imaging unit 201, and may sense an area that cannot be imaged by the imaging unit 201 using the sensor. Further, the road side machine 200 may also transmit sensing information of the sensor together with the captured image. In this case, the control device 114 of the vehicle 100 may receive the sensing information together with the captured image and display a content of the sensing information on the display unit 113 in S504 of FIG. 13. For example, in FIG. 9, when the road side machine 200A includes a sensor capable of sensing an area of a crosswalk, the road side machine 200 transmits the sensing information indicating whether a pedestrian is present on the crosswalk. Further, when the sensing information indicating that the pedestrian is present on the crosswalk is received, the vehicle 100A may display, on the display unit 113 illustrated in FIG. 14, information indicating that the pedestrian is present on the crosswalk. Accordingly, the driver of the vehicle 100A can recognize that the pedestrian is present on the crosswalk into which the right turn is to be made, and can perform the right turn more safely.

### APPENDIX ACCORDING TO SECOND EMBODIMENT

### Appendix 1

A road side machine including:

an imaging unit configured to image a vehicle in a predetermined imaging direction on a road; and

a communication unit configured to output a position of the imaging unit, the predetermined imaging direction, and an image captured by the imaging unit as a communication signal.

### Appendix 2

The road side machine according to Appendix 1, in which

the communication unit includes an antenna that outputs the communication signal as a wireless communication signal.

### Appendix 3

A vehicle including:

at least a first wheel and a second wheel;

a vehicle body coupled to the first wheel and the second wheel;

a wireless communication unit configured to receive a position of an imaging unit provided in a road side machine, an imaging direction of the imaging unit, and an image captured by the imaging unit; and

a display unit, in which

the display unit displays the image captured by the imaging unit based on the position of the imaging unit and the imaging direction of the imaging unit.

### Appendix 4

The vehicle according to Appendix 3, further including:

an operation unit, in which

when the operation unit receives a predetermined operation, the display unit displays the image captured by the imaging unit based on the position of the imaging unit and the imaging direction of the imaging unit.

### Appendix 5

The vehicle according to Appendix 4, in which

a case in which the operation unit receives the predetermined operation is a case in which the operation unit receives an operation of a right turn.

### Appendix 6

The vehicle according to any one of Appendixes 3 to 5, in which

the display unit displays the image captured by the imaging unit in which the imaging direction is common to a direction of the vehicle.

### Appendix 7

The vehicle according to Appendix 6, in which

the display unit displays the image captured by the imaging unit of which the position is closest to a position of the vehicle.

### Appendix 8

A control device mountable on a vehicle including at least a first wheel and a second wheel, a vehicle body coupled to the first wheel and the second wheel, a wireless communication unit configured to receive a position of an imaging unit provided in a road side machine, an imaging direction of the imaging unit, and an image captured by the imaging unit, and a display unit, in which

the control device displays, on the display unit, the image captured by the imaging unit based on the position of the imaging unit and the imaging direction of the imaging unit.

### Appendix 9

The control device according to Appendix 8, in which

the vehicle further includes an operation unit, and

when the operation unit receives a predetermined operation, the control device displays, on the display unit, the image captured by the imaging unit based on the position of the imaging unit and the imaging direction of the imaging unit.

### Appendix 10

The control device according to Appendix 9, in which

a case in which the operation unit receives the predetermined operation is a case in which the operation unit receives an operation of a right turn.

### Appendix 11

The control device according to any one of Appendixes 8 to 10, in which

the control device displays, on the display unit, the image captured by the imaging unit in which the imaging direction is common to a direction of the vehicle.

### Appendix 12

The control device according to Appendix 11, in which

the control device displays, on the display unit, the image captured by the imaging unit of which the position is closest to a position of the vehicle.

### Appendix 13

A vehicle control method usable in a vehicle including at least a first wheel and a second wheel, a vehicle body coupled to the first wheel and the second wheel, a wireless communication unit configured to receive a position of an imaging unit provided in a road side machine, an imaging direction of the imaging unit, and an image captured by the imaging unit, and a display unit, the vehicle control method including:

displaying, on the display unit, the image captured by the imaging unit based on the position of the imaging unit and the imaging direction of the imaging unit.

### Appendix 14

The vehicle control method according to Appendix 13, in which

the vehicle further includes an operation unit, and

when the operation unit receives a predetermined operation, the display unit displays the image captured by the imaging unit based on the position of the imaging unit and the imaging direction of the imaging unit.

### Appendix 15

The vehicle control method according to Appendix 14, in which

a case in which the operation unit receives the predetermined operation is a case in which the operation unit receives an operation of a right turn.

### Appendix 16

The vehicle control method according to any one of Appendixes 13 to 15, in which

the display unit displays the image captured by the imaging unit in which the imaging direction is common to a direction of the vehicle.

### Appendix 17

The vehicle control method according to Appendix 16, in which

the display unit displays the image captured by the imaging unit of which the position is closest to a position of the vehicle.

### (A-1)

A vehicle including a first wireless communication circuit configured to communicate with a first wireless communication terminal, and a second wireless communication circuit configured to communicate with a second wireless communication terminal different from the first wireless communication terminal, the vehicle including:

a manual driving mode in which an occupant of the vehicle manually drives the vehicle, and an autonomous driving mode in which the occupant is capable of autonomously moving the vehicle without boarding the vehicle, in which

in the manual driving mode, when a predetermined relationship with the first wireless communication terminal is established, manual driving by the occupant is possible,

in the manual driving mode, when the predetermined relationship with the first wireless communication terminal is not established, the manual driving by the occupant is impossible,

in the autonomous driving mode, when the predetermined relationship with the first wireless communication terminal is established, transition to the manual driving mode is possible,

in the autonomous driving mode, when the predetermined relationship with the first wireless communication terminal is not established, the transition to the manual driving mode is impossible, and

in the autonomous driving mode, when the predetermined relationship with the first wireless communication terminal is not established, the transition to the manual driving mode is possible by a predetermined operation of the second wireless communication terminal.

### (A-2)

The vehicle according to Appendix A-1, further including:

a control circuit, in which

the control circuit is coupled to at least the first wireless communication circuit and the second wireless communication circuit.

### (A-3)

The vehicle according to Appendix A-1 or A-2, further including:

an opening and closing portion that allows the occupant to enter and exit and includes a lock circuit, in which

in the autonomous driving mode, when the predetermined relationship with the first wireless communication terminal is established, the opening and closing portion is openable and closable,

in the autonomous driving mode, when the predetermined relationship with the first wireless communication terminal is not established, the opening and closing portion is not opened by the lock circuit, and

in the autonomous driving mode, when the predetermined relationship with the first wireless communication terminal is not established, the opening and closing portion is openable and closable by the predetermined operation of the second wireless communication terminal.

### (A-4)

The vehicle according to Appendix A-3, further including:

a display circuit, in which

in the autonomous driving mode, when the predetermined relationship with the first wireless communication terminal is established, the display circuit performs a first display,

in the autonomous driving mode, when the predetermined relationship with the first wireless communication terminal is not established, the display circuit performs a second display, and

in the autonomous driving mode, in a case in which the predetermined relationship with the first wireless communication terminal is not established, when the opening and closing portion is openable and closable by the predetermined operation of the second wireless communication terminal, the display circuit performs a third display different from the first display.

### (A-5)

The vehicle according to Appendix A-4, in which

the second display and the third display are the same.

### (A-6)

The vehicle according to Appendix A-4 or A-5, in which

the display circuit is an in-vehicle display circuit that performs a display toward an inside of the vehicle and/or an out-of-vehicle display circuit that performs a display toward an outside of the vehicle.

### (A-7)

The vehicle according to any one of Appendixes A-1 to A-6, in which

the second wireless communication terminal includes a display circuit, and

when the vehicle is capable of transitioning to the manual driving mode by the predetermined operation of the second wireless communication terminal, the display circuit of the second wireless communication terminal displays that the vehicle is capable of transitioning to the manual driving mode.

### (A-8)

The vehicle according to any one of Appendixes A-1 to A-6, further including:

a vehicle body, and

a first wheel and a second wheel which are coupled to the vehicle body, in which

the vehicle is movable using the first wheel and the second wheel.

### (A-9)

The vehicle according to any one of Appendixes A-1 to A-8, in which

the first wireless communication circuit includes a first antenna, and

the second wireless communication circuit includes a second antenna.

### (A-10)

The vehicle according to any one of Appendixes A-1 to A-9, in which

the first wireless communication circuit and the second wireless communication circuit are the same.

### (A-11)

A control device mountable on a vehicle including a first wireless communication circuit configured to communicate with a first wireless communication terminal, and a second wireless communication circuit configured to communicate with a second wireless communication terminal different from the first wireless communication terminal, the control device including:

a manual driving mode in which an occupant of the vehicle manually drives the vehicle, and an autonomous driving mode in which the occupant is capable of autonomously moving the vehicle without boarding the vehicle, in which

in the manual driving mode, when a predetermined relationship with the first wireless communication terminal is established, manual driving by the occupant is possible,

in the manual driving mode, when the predetermined relationship with the first wireless communication terminal is not established, the manual driving by the occupant is impossible,

in the autonomous driving mode, when the predetermined relationship with the first wireless communication terminal is established, transition to the manual driving mode is possible,

in the autonomous driving mode, when the predetermined relationship with the first wireless communication terminal is not established, the transition to the manual driving mode is impossible, and

in the autonomous driving mode, when the predetermined relationship with the first wireless communication terminal is not established, the transition to the manual driving mode is possible by a predetermined operation of the second wireless communication terminal.

### (A-12)

The control device according to Appendix A-11, further including:

a control circuit, in which

the control circuit is coupled to at least the first wireless communication circuit and the second wireless communication circuit.

### (A-13)

The control device according to Appendix A-11 or A-12, in which

the vehicle further includes an opening and closing portion that allows the occupant to enter and exit and includes a lock circuit,

in the autonomous driving mode, when the predetermined relationship with the first wireless communication terminal is established, the opening and closing portion is openable and closable,

in the autonomous driving mode, when the predetermined relationship with the first wireless communication terminal is not established, the opening and closing portion is not opened by the lock circuit, and

in the autonomous driving mode, when the predetermined relationship with the first wireless communication terminal is not established, the opening and closing portion is openable and closable by the predetermined operation of the second wireless communication terminal.

### (A-14)

The control device according to Appendix A-13, in which

the vehicle further includes a display circuit,

in the autonomous driving mode, when the predetermined relationship with the first wireless communication terminal is established, the display circuit performs a first display,

in the autonomous driving mode, when the predetermined relationship with the first wireless communication terminal is not established, the display circuit performs a second display, and

in the autonomous driving mode, in a case in which the predetermined relationship with the first wireless communication terminal is not established, when the opening and closing portion is openable and closable by the predetermined operation of the second wireless communication terminal, the display circuit performs a third display different from the first display.

### (A-15)

The control device according to Appendix A-14, in which

the second display and the third display are the same.

### (A-16)

The control device according to Appendix A-14 or A-15, in which

the display circuit is an in-vehicle display circuit that performs a display toward an inside of the vehicle and/or an out-of-vehicle display circuit that performs a display toward an outside of the vehicle.

### (A-17)

The control device according to any one of Appendixes A-11 to A-16, in which

the second wireless communication terminal includes a display circuit, and

when the vehicle is capable of transitioning to the manual driving mode by the predetermined operation of the second wireless communication terminal, the display circuit of the second wireless communication terminal displays that the vehicle is capable of transitioning to the manual driving mode.

### (A-18)

The control device according to any one of Appendixes A-11 to A-16, in which

the vehicle further includes
a vehicle body, and
a first wheel and a second wheel which are coupled to the vehicle body, and

the vehicle is movable using the first wheel and the second wheel.

### (A-19)

The control device according to any one of Appendixes A-11 to A-18, in which

the first wireless communication circuit of the vehicle includes a first antenna, and

the second wireless communication circuit of the vehicle includes a second antenna.

### (A-20)

The control device according to any one of Appendixes A-11 to A-19, in which

the first wireless communication circuit of the vehicle and the second wireless communication circuit of the vehicle are the same.

### Third Embodiment

In a third embodiment, the same components as those described in the first or second embodiment are denoted by the same reference signs, and the description thereof may be omitted.

<Process Flow>

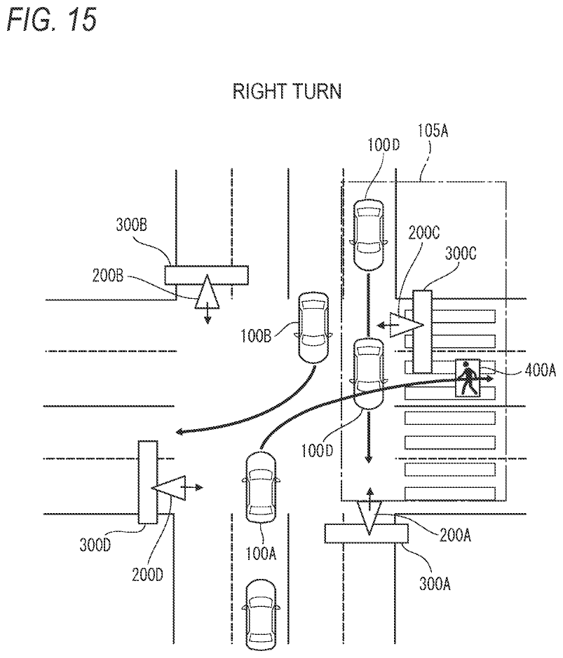

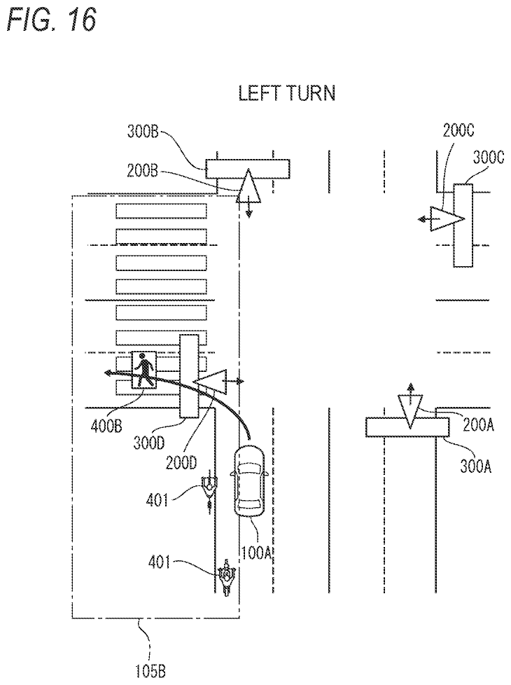

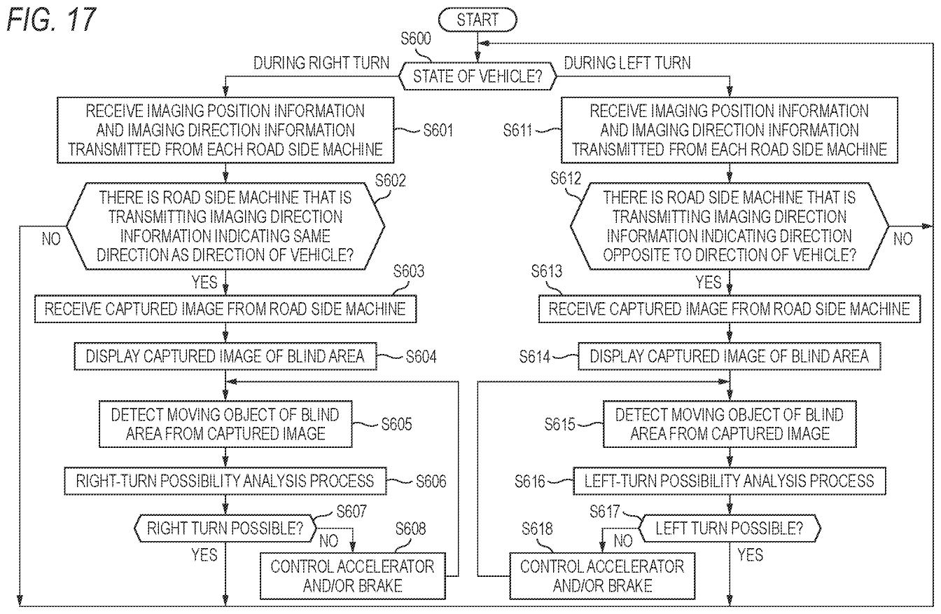

FIG. 15 is a schematic diagram illustrating a situation in which the vehicle 100A according to the third embodiment turns right at an intersection. FIG. 16 is a schematic diagram illustrating a situation in which the vehicle 100A according to the third embodiment turns left at the intersection. FIG. 17 is a flowchart illustrating an example of a driving assist process according to the third embodiment. Next, operation of vehicle 100A according to the third embodiment will be described with reference to FIGS. 15 to 17. The vehicle 100A and the road side machine 200 according to the third embodiment may have the configurations of the vehicle 100 and the road side machine 200 illustrated in FIG. 11.

In S600, the control device 114 of the vehicle 100A determines whether the vehicle 100A is turning right or turning left.

A state of “turning right” may be a period from a right-turn start timing to a right-turn end timing. The right-turn start timing may be a timing at which a winker operation of the right turn is turned on, a timing at which the steering wheel is rotated to the right, or a timing at which the guidance of the right turn is started in the navigation device. The right-turn end timing may be a timing at which the winker operation of the right turn is turned off, a timing at which the steering wheel rotated to the right is returned to an original position, or a timing at which the guidance of the right turn is ended in the navigation device.

A state of “turning left” may be a period from a left-turn start timing to a left-turn end timing. The left-turn start timing may be a timing at which a winker operation of a left turn is turned on, a timing at which the steering wheel is rotated to the left, or a timing at which guidance of the left turn is started in the navigation device. The left-turn end timing may be a timing at which the winker operation of the left turn is turned off, a timing at which the steering wheel rotated to the left is returned to the original position, or a timing at which the guidance of the left turn is ended in the navigation device.

When it is determined in S600 that the vehicle 100A is neither turning right nor turning left, the control device 114 may repeat a determination process of S600.

First, a case in which it is determined in S600 that the vehicle 100A is turning right will be described.

In S601, the wireless communication unit 111 of the vehicle 100A receives imaging position information and imaging direction information (that is, V2I information) transmitted from each road side machine 200 by a broadcast as V2I communication.

In S602, the control device 114 of the vehicle 100A determines whether there is the road side machine 200 that is transmitting the imaging direction information indicating the same direction as a traveling direction of the vehicle 100A in the imaging direction information received in S601. The phrase that the traveling direction of the vehicle 100A and the direction in the imaging direction information are the same means that the two directions are not required to be exactly the same, and may be the same within a predetermined angular range.

In a case in which the control device 114 of the vehicle 100A determines that there is no road side machine 200 that is transmitting the imaging direction information indicating the same direction as the traveling direction of the vehicle 100A in S602 (S602: NO), the process is returned to S600.

In a case in which the control device 114 of the vehicle 100A determines that there is the road side machine 200A (see FIG. 15) that is transmitting the imaging direction information indicating the same direction as the traveling direction of the vehicle 100A in S602 (S602: YES), the process advances to S603.

In S603, the wireless communication unit 111 of the vehicle 100A receives a captured image (that is, the V2I information) transmitted as the V2I communication from the road side machine 200A that is transmitting the imaging direction information indicating the same direction as the traveling direction of the vehicle 100A.

In S604, the display unit 113 of the vehicle 100A displays the captured image received in S603. Therefore, a captured image indicating a situation of a blind area 105A viewed from a driver of the vehicle 100A who is turning right is automatically selected from captured images transmitted from the road side machines 200 (imaging units 201) set at the intersection, and is displayed on the display unit 113. Accordingly, the driver can recognize the situation of the blind area 105A from the captured image which is displayed, and can safely turn right.

In S605, the control device 114 of the vehicle 100A performs analysis for detecting a moving object in the captured image of the blind area 105A received in S603. Examples of the moving object include an automobile (for example, an oncoming vehicle 100D (see FIG. 15)), a pedestrian 400A (see FIG. 15), a bicycle, and a motorcycle.

In S606, the control device 114 of the vehicle 100A executes a right-turn possibility analysis process of analyzing whether the vehicle 100A can safely turn right based on a detection result of the moving object in S605. For example, as the right-turn possibility analysis process, the control device 114 of the vehicle 100A analyzes whether the vehicle 100A can safely turn right based on a priority order according to a traffic regulation (for example, the oncoming vehicle 100D traveling in a straight line has a higher priority than the vehicle 100A turning right), whether the moving object is detected in S605, an estimated speed of the detected moving object (for example, the oncoming vehicle 100D), an estimated distance between the detected moving object (for example, the oncoming vehicle 100D) and the vehicle 100A, and the like.

In S607, the control device 114 of the vehicle 100A determines whether the vehicle 100A can safely turn right based on an analysis result of S606. For example, when no moving object is detected, or when the estimated distance between the detected moving object (for example, the oncoming vehicle 100D) and the vehicle 100A is equal to or greater than a predetermined threshold value, the control device 114 determines that the vehicle 100A can safely turn right. For example, when the estimated distance between the detected moving object (for example, the oncoming vehicle 100D) and the vehicle 100A is less than the predetermined threshold value, the control device 114 determines that the vehicle 100A cannot safely turn right.

When it is determined in S607 that the vehicle 100A can safely turn right (S607: YES), the control device 114 of the vehicle 100A returns the process to S600. That is, the vehicle 100A continues a behavior of a right turn.

When it is determined in S607 that the vehicle 100A cannot safely turn right (S607: NO), in S608, the control device 114 of the vehicle 100A decelerates or stops the vehicle 100A. For example, even if the driver of the vehicle 100A depresses an accelerator, the control device 114 performs control so as not to increase an accelerator opening degree or applies a brake. Accordingly, for example, even if the driver erroneously depresses the accelerator in a case in which the vehicle 100A cannot safely turn right, the progress of the vehicle 100A is prevented, and an occurrence of an accident at the time of the right turn (for example, a collision accident with the oncoming vehicle 100D) can be prevented. Further, the control device 114 of the vehicle 100A returns the process to S605.

Next, a case in which it is determined in S600 that the vehicle 100A is turning left will be described.

In S611, the wireless communication unit 111 of the vehicle 100A receives imaging position information and imaging direction information (that is, the V2I information) transmitted from each road side machine 200 by a broadcast as the V2I communication.

In S612, the control device 114 of the vehicle 100A determines whether there is the road side machine 200 that is transmitting the imaging direction information indicating a direction opposite to a traveling direction of the vehicle 100A in the imaging direction information received in S611. The phrase that the traveling direction of the vehicle 100A and the direction in the imaging direction information are opposite means that the two directions are not required to be exactly opposite, and may be opposite within a predetermined angular range.

In a case in which the control device 114 of the vehicle 100A determines that there is no road side machine 200 that is transmitting the imaging direction information indicating the direction opposite to the traveling direction of the vehicle 100A in S612 (S612: NO), the process is returned to S600.

In a case in which the control device 114 of the vehicle 100A determines that there is the road side machine 200B (see FIG. 16) that is transmitting the imaging direction information indicating the direction opposite to the traveling direction of the vehicle 100A in S612 (S612: YES), the process advances to S613.

In S613, the wireless communication unit 111 of the vehicle 100A receives a captured image (that is, the V2I information) transmitted as the V2I communication from the road side machine 200B that is transmitting the imaging direction information indicating the direction opposite to the traveling direction of the vehicle 100A.

In S614, the display unit 113 of the vehicle 100A displays the captured image received in S613. Accordingly, a captured image indicating a situation of a blind area 105B viewed from the driver of the vehicle 100A who is turning left is automatically selected from the captured images transmitted from the road side machines 200 (imaging units 201) set at the intersection, and is displayed on the display unit 113. Accordingly, the driver can recognize the situation of the blind area 105B from the captured image which is displayed, and can safely turn left.

In S615, the control device 114 of the vehicle 100A performs analysis for detecting a moving object on the captured image of the blind area 105B received in S613. Examples of the moving object include an automobile, a pedestrian 400B (see FIG. 16), a bicycle 401 (see FIG. 16), and a motorcycle.

In S616, the control device 114 of the vehicle 100A executes a left-turn possibility analysis process of analyzing whether the vehicle 100A can safely turn left based on a detection result of the moving object in S615. For example, as the left-turn possibility analysis process, the control device 114 of the vehicle 100A analyzes whether the vehicle 100A can safely turn left based on the priority order according to the traffic regulation, whether the moving object is detected in S615, the estimated speed of the detected moving object (for example, the bicycle 401 on a left rear side of the vehicle 100A), the estimated distance between the detected moving object (for example, the bicycle 401 on the left rear side of the vehicle 100A) and the vehicle 100A, and the like.

In S617, the control device 114 of the vehicle 100A determines whether the vehicle 100A can safely turn left based on an analysis result of S616. For example, when no moving object is detected, or when the estimated distance between the detected moving object (for example, the bicycle 401 on the left rear side) and the vehicle 100A is equal to or greater than the predetermined threshold value, the control device 114 determines that the vehicle 100A can safely turn left. For example, when the estimated distance between the detected moving object (for example, the bicycle 401 on the left rear side) and the vehicle 100A is less than the predetermined threshold value, the control device 114 determines that the vehicle 100A cannot safely turn left.

When it is determined in S617 that the vehicle 100A can safely turn left (S617: YES), the control device 114 of the vehicle 100A returns the process to S600. That is, the vehicle 100A continues a behavior of a left turn.

When it is determined in S617 that the vehicle 100A cannot safely turn left (S617: NO), in S618, the control device 114 of the vehicle 100A decelerates or stops the vehicle 100A. For example, even if the driver of the vehicle 100A depresses an accelerator, the control device 114 performs control so as not to increase an accelerator opening degree or applies a brake. Accordingly, for example, even if the driver erroneously depresses the accelerator in the case in which the vehicle 100A cannot safely turn left, the progress of the vehicle 100A is prevented, and an occurrence of an accident at the time of the left turn (for example, an accident involving the bicycle 401) can be prevented. Further, the control device 114 returns the process to S605.

### <Display Example>

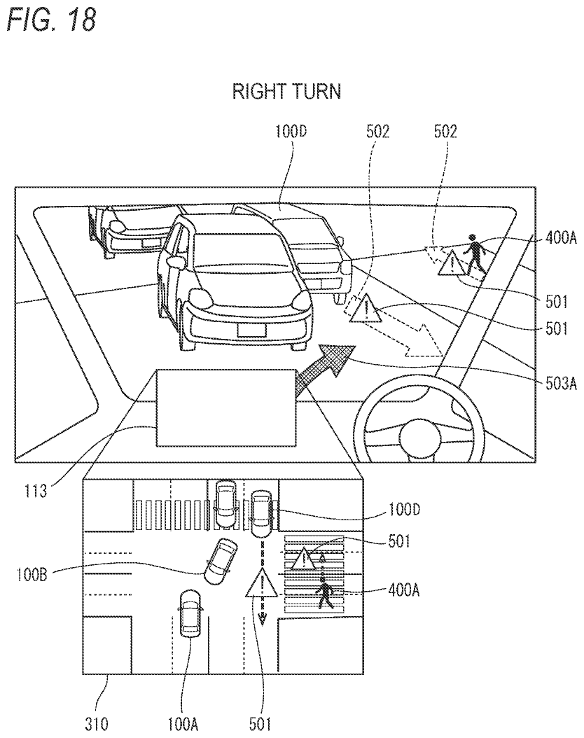

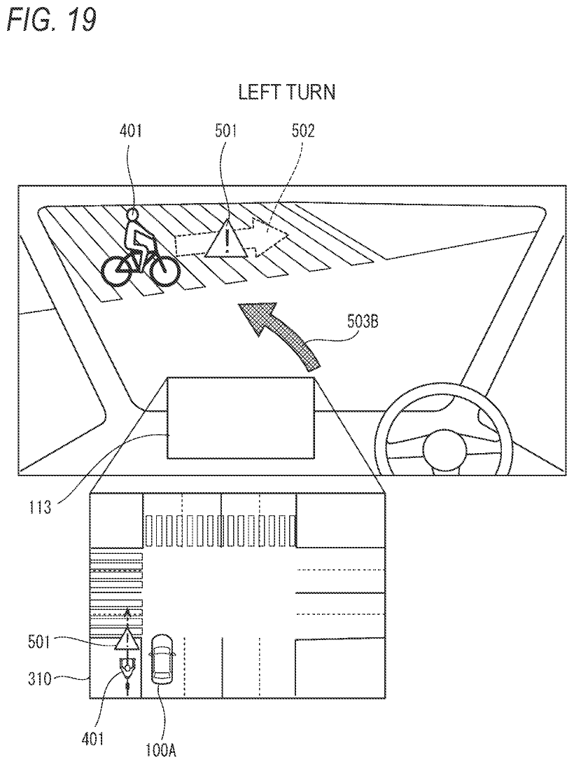

FIG. 18 is a schematic diagram illustrating an example of a captured image displayed by the display unit 113 when the vehicle 100A according to the third embodiment turns right. FIG. 19 is a schematic diagram illustrating an example of the captured image displayed by the display unit 113 when the vehicle 100A according to the third embodiment turns left.

The control device 114 of the vehicle 100A that is turning right may display the captured image 310 on the display unit 113 as illustrated in FIG. 18 in the process of S604 illustrated in FIG. 17. In FIG. 18, the captured image 310 obtained by observing the intersection from above is illustrated as an example, but the captured image 310 is not limited thereto. For example, the captured image 310 may be an image obtained by looking down in a direction facing the traffic signal 300A (for example, looking obliquely downward) from an upper position corresponding to a position of the traffic signal 300A (see FIG. 15).

When the moving object such as the oncoming vehicle 100D or the pedestrian 400A is present in the blind area 105A, the control device 114 may display a warning image 501 on the display unit 113 and/or a head-up display (HUD). The control device 114 may display an arrow 502 indicating a moving direction of the moving object (for example, the oncoming vehicle 100D or the pedestrian 400A) on the display unit 113 and/or the HUD. The control device 114 may display an arrow 503A guiding the right turn of the vehicle 100A on the display unit 113 and/or the HUD.

The control device 114 of the vehicle 100A that is turning left may display the captured image 310 on the display unit 113 as illustrated in FIG. 19 in the process of S614 illustrated in FIG. 17. In FIG. 19, the captured image 310 obtained by observing the intersection from above is illustrated as an example, but the captured image 310 is not limited thereto. For example, the captured image 310 may be an image obtained by looking down in a direction facing the traffic signal 300B (for example, looking obliquely downward) from an upper position corresponding to a position of the traffic signal 300B (see FIG. 16).

When the moving object such as the bicycle 401 is present in the blind area 105B, the control device 114 may display the warning image 501 on the display unit 113 and/or the HUD. The control device 114 may display the arrow 502 indicating the moving direction of the moving object (for example, the bicycle 401) on the display unit 113 and/or the HUD. The control device 114 may display an arrow 503B guiding the left turn of the vehicle 100A on the display unit 113 and/or the HUD.

The control device 114 may display the warning image 501 according to a degree of risk. For example, the control device 114 may calculate the degree of risk for each moving object, display the warning image 501 for a moving object having the degree of risk equal to or greater than a predetermined threshold value, and not display the warning image 501 for a moving object having the degree of risk less than the predetermined threshold value. The degree of risk may be calculated based on the moving direction and a speed of the moving object, a distance between the vehicle 100A and the moving object, and the like.

For example, as a result of calculating the distance between the vehicle 100A and the moving object, the moving direction and the speed of the moving object, and the like in the right-turn possibility analysis process (S606), when the control device 114 predicts that the moving object present in the current blind area 105A arrives on a route along which the vehicle 100A will travel, the control device 114 displays the warning image 501 in order from the moving object close to the vehicle 100A and in order of a possibility of colliding with the vehicle 100A first. In the order of moving objects that may collide with the vehicle 100A first, even if the moving object is a moving object that is slightly far from the vehicle 100A, when the speed of the moving object is high, a priority order of the moving object may be high.

For example, the control device 114 may increase frequency of blinking for the warning image 501 having a higher degree of risk (for example, the warning image 501 for the moving object closer to the vehicle 100A).

For example, the control device 114 may change a display size of the warning image 501 in accordance with the degree of risk of the moving object or the distance from the moving object. For example, the control device 114 displays, in a larger size, an icon (400A, 401, or the like) indicating a type (for example, a vehicle, a pedestrian, a bicycle, or a pedestrian) of the moving object and/or the warning image 501 for the moving object close to the vehicle 100A, a moving object having a higher speed even if the moving object is slightly far from the vehicle 100A, a moving object having a possibility of collision, or a moving object having a higher degree of risk.

For example, the control device 114 may display the warning images 501 in different colors according to the type of the moving object. For example, the control device 114 may display the warning images 501 in the different colors depending on whether the type of the moving object is a vehicle, a pedestrian, a bicycle, or a motorcycle.

For example, when the warning image 501 is displayed as an arrow, the control device 114 may change a size, a color, a length, and the like of the warning image 501 of the arrow in accordance with the degree of risk. For example, as in the case of the warning image 501 or the icon indicating the type of the moving object described above, the warning image 501 of the arrow may be displayed in a manner of being larger, longer, and clearer as the distance from the vehicle 100A is shorter or the degree of risk is higher.

In this way, by changing a display mode of the warning image 501 according to the degree of risk, it is possible to reduce a possibility that the driver overlooks the warning image 501 having the high degree of risk. The driver can recognize the degree of risk based on a difference in the display mode of the warning image 501. Accordingly, driving safety is improved.

### APPENDIXES ACCORDING TO THIRD EMBODIMENT

The third embodiment can be expressed as the following Appendixes.

### Appendix 1

The vehicle 100A including at least the first wheel 102a and the second wheel 102b, the vehicle body 101 coupled to the first wheel 102a and the second wheel 102b, the wireless communication unit 111 configured to receive an imaging direction of the imaging unit 201 provided in the road side machine 200 and the image captured by the imaging unit 201, the display unit 113, and the operation unit 112, in which the display unit 113 displays the image captured by the imaging unit 201 (road side machine 200A) in the same imaging direction as a traveling direction of the vehicle 100A when the operation unit 112 receives an operation of a right turn, and displays the image captured by the imaging unit 201 (road side machine 200B) in the imaging direction opposite to the traveling direction of the vehicle 100A when the operation unit 112 receives an operation of a left turn.

Accordingly, in the case of the right turn, the vehicle 100A can display an image obtained by capturing an area that is a blind spot for the driver when turning right, and in the case of the left turn, the vehicle 100A can display an image obtained by capturing an area that is a blind spot for the driver when turning left. Accordingly, the driver of the vehicle 100A can check the displayed image and perform the right turn and the left turn more safely.

### Appendix 2

The vehicle 100A according to Appendix 1, in which the vehicle 100A may determine whether a safe right-turn is possible based on an analysis result of the image captured by the imaging unit 201 in the same imaging direction as the traveling direction of the vehicle 100A when the operation unit 112 receives the operation of the right turn, and may determine whether a safe left-turn is possible based on the analysis result of the image captured by the imaging unit 201 in the imaging direction opposite to the traveling direction of the vehicle 100A when the operation unit 112 receives the operation of the left turn.

Accordingly, in the case of the right turn, the vehicle 100A can determine safety of the right turn based on the image obtained by imaging the area that is the blind spot at the time of the right turn, and in the case of the left turn, the vehicle 100A can determine safety of the left turn based on the image obtained by imaging the area that is the blind spot at the time of the left turn. Accordingly, the vehicle 100A can more appropriately determine the safety in each of the right turn and the left turn.

### Appendix 3

The vehicle 100A according to Appendix 2, in which the vehicle 100A may decelerate or stop when determining that the safe right-turn or left-turn is not possible in the determination.

Accordingly, even if the driver erroneously depresses the accelerator in the case in which the vehicle 100A cannot safely turn right or left, the progress of the vehicle 100A is prevented. Accordingly, the occurrence of the accident can be prevented.

### Appendix 4

The vehicle 100A according to Appendix 2 or 3, in which when the vehicle 100A determines that the safe right-turn or left-turn is not possible in the determination, the display unit 113 may display the warning image 501.

Accordingly, since the warning image 501 is displayed when the vehicle 100A cannot turn right or left safely, the driver can check the displayed warning image 501 and turn right or left more safely.

### Appendix 5

The vehicle 100A according to Appendix 4, in which the display unit 113 may change a display mode of the warning image 501 in accordance with a degree of risk of the right turn or the left turn.

Accordingly, it is possible to reduce the possibility that the driver overlooks the warning image 501 having the high degree of risk.

Although the above Appendixes 1 to 5 have mainly described the vehicle 100A, the above Appendixes 1 to 5 can also be read mainly in terms of the control device 114 in the vehicle 100A or a vehicle control method that is usable in the vehicle 100A.

### (B-1)

The vehicle including:

at least a first wheel and a second wheel;

a vehicle body coupled to the first wheel and the second wheel;

a wireless communication unit configured to receive an imaging direction of an imaging unit provided in a road side machine and an image captured by the imaging unit;

a display unit; and

an operation unit, in which

the display unit

displays the image captured by the imaging unit in the same imaging direction as a traveling direction of the vehicle when the operation unit receives an operation of a right turn, and

displays the image captured by the imaging unit in the imaging direction opposite to the traveling direction of the vehicle when the operation unit receives an operation of a left turn.

### (B-2)

The vehicle according to B-1, in which

the vehicle determines whether a safe right-turn is possible based on an analysis result of the image captured by the imaging unit in the same imaging direction as the traveling direction of the vehicle when the operation unit receives the operation of the right turn, and

the vehicle determines whether a safe left-turn is possible based on the analysis result of the image captured by the imaging unit in the imaging direction opposite to the traveling direction of the vehicle when the operation unit receives the operation of the left turn.

### (B-3)

The vehicle according to B-2, in which

the vehicle decelerates or stops when determining that the safe right-turn or left-turn is not possible in the determination.

### (B-4)

The vehicle according to B-2 or B-3, in which

when the vehicle determines that the safe right-turn or left-turn is not possible in the determination, the display unit displays a warning image.

### (B-5)

The vehicle according to B-4, in which

the display unit changes a display mode of the warning image in accordance with a degree of risk of the right turn or the left turn.

### (B-6)

A control device capable of controlling a vehicle including at least a first wheel and a second wheel, a vehicle body coupled to the first wheel and the second wheel, a wireless communication unit configured to receive an imaging direction of an imaging unit provided in a road side machine and an image captured by the imaging unit, a display unit, and an operation unit, in which

the display unit

displays the image captured by the imaging unit in the same imaging direction as a traveling direction of the vehicle when the operation unit receives an operation of a right turn, and

displays the image captured by the imaging unit in the imaging direction opposite to the traveling direction of the vehicle when the operation unit receives an operation of a left turn.

### (B-7)

The control device according to B-6, in which

the control device determines whether a safe right-turn is possible based on an analysis result of the image captured by the imaging unit in the same imaging direction as the traveling direction of the vehicle when the operation unit receives the operation of the right turn, and

the control device determines whether a safe left-turn is possible based on the analysis result of the image captured by the imaging unit in the imaging direction opposite to the traveling direction of the vehicle when the operation unit receives the operation of the left turn.

### (B-8)

The control device according to B-7, in which

the control device decelerates or stops the vehicle when determining that the safe right-turn or left-turn is not possible in the determination.

### (B-9)

The control device according to B-7 or B-8, in which

when determining that the safe right-turn or left-turn is not possible in the determination, the control device displays a warning image on the display unit.

### (B-10)

The control device according to B-9, in which

the control device changes a display mode of the warning image in accordance with a degree of risk of the right turn or the left turn.

### (B-11)

A vehicle control method usable in a vehicle including at least a first wheel and a second wheel, a vehicle body coupled to the first wheel and the second wheel, a wireless communication unit configured to receive an imaging direction of an imaging unit provided in a road side machine and an image captured by the imaging unit, a display unit, and an operation unit, the vehicle control method including:

on the display unit,

displaying the image captured by the imaging unit in the same imaging direction as a traveling direction of the vehicle when the operation unit receives an operation of a right turn; and

displaying the image captured by the imaging unit in the imaging direction opposite to the traveling direction of the vehicle when the operation unit receives an operation of a left turn.

### (B-12)

The vehicle control method according to B-11, further including:

determining whether a safe right-turn is possible based on an analysis result of the image captured by the imaging unit in the same imaging direction as the traveling direction of the vehicle when the operation unit receives the operation of the right turn; and

determining whether a safe left-turn is possible based on the analysis result of the image captured by the imaging unit in the imaging direction opposite to the traveling direction of the vehicle when the operation unit receives the operation of the left turn.

### (B-13)

The vehicle control method according to B-12, further including:

decelerating or stopping the vehicle when it is determined that the safe right-turn or left-turn is not possible in the determination.

### (B-14)

The vehicle control method according to B-12 or B-13, further including:

displaying a warning image on the display unit when it is determined that the safe right-turn or left-turn is not possible in the determination.

### (B-15)

The vehicle control method according to B-14, further including:

changing a display mode of the warning image in accordance with a degree of risk of the right turn or the left turn.

Although various embodiments have been described above with reference to the drawings, it is needless to say that the present invention is not limited to these embodiments. It is apparent that those skilled in the art can conceive of various modifications and alterations within the scope described in the claims, and it is understood that such modifications and alterations naturally fall within the technical scope of the present invention. The components in the embodiment described above may be freely combined without departing from the gist of the invention.

The present application is based on Japanese Patent Application No. 2020-190452 filed on Nov. 16, 2020, and the contents thereof are incorporated herein by reference. The present application is based on Japanese Patent Application No. 2020-210466 filed on Dec. 18, 2020, and the contents thereof are incorporated herein by reference.

### INDUSTRIAL APPLICABILITY

The technique according the present disclosure is useful for driving assistance of a vehicle.

What is claimed is:

1. A vehicle including a first wireless communication circuit configured to communicate with a first wireless communication terminal, and a second wireless communication circuit configured to communicate with a second wireless communication terminal different from the first wireless communication terminal, the vehicle comprising:
a manual driving mode in which an occupant of the vehicle manually drives the vehicle, and an autonomous driving mode in which the occupant is capable of autonomously moving the vehicle without boarding the vehicle, wherein
in the manual driving mode, when a predetermined relationship with the first wireless communication terminal is established, manual driving by the occupant is possible,
in the manual driving mode, when the predetermined relationship with the first wireless communication terminal is not established, the manual driving by the occupant is impossible,
in the autonomous driving mode, when the predetermined relationship with the first wireless communication terminal is established, transition to the manual driving mode is possible,
in the autonomous driving mode, when the predetermined relationship with the first wireless communication terminal is not established, the transition to the manual driving mode is impossible, and
in the autonomous driving mode, when the predetermined relationship with the first wireless communication terminal is not established, the transition to the manual driving mode is possible by a predetermined operation of the second wireless communication terminal.

2. The vehicle according to claim 1, further comprising:
a control circuit, wherein
the control circuit is coupled to at least the first wireless communication circuit and the second wireless communication circuit.

3. The vehicle according to claim 1, further comprising:
an opening and closing portion that allows the occupant to enter and exit and includes a lock circuit, wherein
in the autonomous driving mode, when the predetermined relationship with the first wireless communication terminal is established, the opening and closing portion is openable and closable,
in the autonomous driving mode, when the predetermined relationship with the first wireless communication terminal is not established, the opening and closing portion is not opened by the lock circuit, and
in the autonomous driving mode, when the predetermined relationship with the first wireless communication terminal is not established, the opening and closing portion is openable and closable by the predetermined operation of the second wireless communication terminal.

4. The vehicle according to claim 3, further comprising:
a display circuit, wherein
in the autonomous driving mode, when the predetermined relationship with the first wireless communication terminal is established, the display circuit performs a first display,
in the autonomous driving mode, when the predetermined relationship with the first wireless communication terminal is not established, the display circuit performs a second display, and
in the autonomous driving mode, in a case in which the predetermined relationship with the first wireless communication terminal is not established, when the opening and closing portion is openable and closable by the predetermined operation of the second wireless communication terminal, the display circuit performs a third display different from the first display.

5. The vehicle according to claim 4, wherein
the second display and the third display are the same.

6. The vehicle according to claim 4, wherein
the display circuit is an in-vehicle display circuit that performs a display toward an inside of the vehicle or an out-of-vehicle display circuit that performs a display toward an outside of the vehicle.

7. The vehicle according to claim 1, wherein
the second wireless communication terminal includes a display circuit, and
when the vehicle is capable of transitioning to the manual driving mode by the predetermined operation of the second wireless communication terminal, the display circuit of the second wireless communication terminal displays that the vehicle is capable of transitioning to the manual driving mode.

8. The vehicle according to claim 1, further comprising:
a vehicle body, and
a first wheel and a second wheel which are coupled to the vehicle body, wherein
the vehicle is movable using the first wheel and the second wheel.

9. The vehicle according to claim 1, wherein
the first wireless communication circuit includes a first antenna, and
the second wireless communication circuit includes a second antenna.

10. The vehicle according to claim 1, wherein
the first wireless communication circuit and the second wireless communication circuit are the same.

11. A control device mountable on a vehicle including a first wireless communication circuit configured to communicate with a first wireless communication terminal, and a second wireless communication circuit configured to communicate with a second wireless communication terminal different from the first wireless communication terminal, the control device comprising:
a manual driving mode in which an occupant of the vehicle manually drives the vehicle, and an autonomous driving mode in which the occupant is capable of autonomously moving the vehicle without boarding the vehicle, wherein
in the manual driving mode, when a predetermined relationship with the first wireless communication terminal is established, manual driving by the occupant is possible,
in the manual driving mode, when the predetermined relationship with the first wireless communication terminal is not established, the manual driving by the occupant is impossible,
in the autonomous driving mode, when the predetermined relationship with the first wireless communication terminal is established, transition to the manual driving mode is possible,
in the autonomous driving mode, when the predetermined relationship with the first wireless communication terminal is not established, the transition to the manual driving mode is impossible, and
in the autonomous driving mode, when the predetermined relationship with the first wireless communication terminal is not established, the transition to the manual driving mode is possible by a predetermined operation of the second wireless communication terminal.

12. The control device according to claim 11, further comprising:
a control circuit, wherein
the control circuit is coupled to at least the first wireless communication circuit and the second wireless communication circuit.

13. The control device according to claim 11, wherein
the vehicle further includes an opening and closing portion that allows the occupant to enter and exit and includes a lock circuit,
in the autonomous driving mode, when the predetermined relationship with the first wireless communication terminal is established, the opening and closing portion is openable and closable,
in the autonomous driving mode, when the predetermined relationship with the first wireless communication terminal is not established, the opening and closing portion is not opened by the lock circuit, and
in the autonomous driving mode, when the predetermined relationship with the first wireless communication terminal is not established, the opening and closing portion is openable and closable by the predetermined operation of the second wireless communication terminal.

14. The control device according to claim 13, wherein
the vehicle further includes a display circuit,
in the autonomous driving mode, when the predetermined relationship with the first wireless communication terminal is established, the display circuit performs a first display,
in the autonomous driving mode, when the predetermined relationship with the first wireless communication terminal is not established, the display circuit performs a second display, and
in the autonomous driving mode, in a case in which the predetermined relationship with the first wireless communication terminal is not established, when the opening and closing portion is openable and closable by the predetermined operation of the second wireless communication terminal, the display circuit performs a third display different from the first display.

15. The control device according to claim 14, wherein
the second display and the third display are the same.

16. The control device according to claim 14, wherein
the display circuit is an in-vehicle display circuit that performs a display toward an inside of the vehicle or an out-of-vehicle display circuit that performs a display toward an outside of the vehicle.

17. The control device according to claim 11, wherein
the second wireless communication terminal includes a display circuit, and
when the vehicle is capable of transitioning to the manual driving mode by the predetermined operation of the second wireless communication terminal, the display circuit of the second wireless communication terminal displays that the vehicle is capable of transitioning to the manual driving mode.

18. The control device according to claim 11, wherein
the vehicle further includes
a vehicle body, and
a first wheel and a second wheel which are coupled to the vehicle body, and
the vehicle is movable using the first wheel and the second wheel.

19. The control device according to claim 11, wherein
the first wireless communication circuit of the vehicle includes a first antenna, and
the second wireless communication circuit of the vehicle includes a second antenna.

20. The control device according to claim 11, wherein
the first wireless communication circuit of the vehicle and the second wireless communication circuit of the vehicle are the same.
